(19) United States
(12) Patent Application Publication
(10) Pub. No.: US 2010/0320341 A1
(43) Pub. Date: Dec. 23, 2010

(54) Universal Stands for Portable Electronic Devices

(75) Inventors: Scott Baumann, Anacortes, WA (US); Brian Wheeler, Bellingham, WA (US); Brian Johnson, Anacortes, WA (US)

Correspondence Address: HANSRA PATENT SERVICES, 4525 GLEN MEADOWS PLACE, BELLINGHAM, WA, 98226, US

(73) Assignee: CLINGO.COM LLC, Ferndale, WA (US)

(21) Appl. No.: 12/786,420

(22) Filed: May 24, 2010

Related U.S. Application Data
(60) Provisional application No. 61/180,827, filed on May 22, 2009.
(60) Provisional application No. 61/233,129, filed on Aug. 11, 2009.
(60) Provisional application No. 61/241,024, filed on Sep. 9, 2009.
(60) Provisional application No. 61/259,631, filed on Nov. 9, 2009.

(51) Int. Cl. F16B 47/00; F16M 13/00

(52) U.S. Cl. 248/206.2; 248/309.1; 248/299.1; 248/274.1; 248/288.31

(57) ABSTRACT

The present invention is directed to universal stands for portable electronic devices. In one embodiment, a stand includes a display platform and a gripping pad attached to the display platform for releasably securing a portable electronic device thereto.

### CROSS-REFERENCE TO RELATED APPLICATIONS

This application claims the benefit of U.S. Provisional Application No. 61/180,827, filed May 22, 2009; U.S. Provisional Application No. 61/233,129, filed Aug. 11, 2009; U.S. Provisional Application No. 61/241,024, filed Sep. 9, 2009; and, U.S. Provisional Application No. 61/259,631, filed Nov. 9, 2009. The aforementioned applications are incorporated herein by reference in their entireties.

### FIELD OF THE INVENTION

The present invention relates generally to stands. More particularly, the present invention relates to stands for portable electronic devices.

### BACKGROUND OF THE INVENTION

There are a great variety of portable electronic devices including, for example, mobile telephones, handheld gaming devices, video players, video recorders, navigation systems, laptop computers, netbook computers, tablet computers, computer monitors, wireless reading devices, personal digital assistants, audio recorders and music players. Certainly, many more types of portable electronic devices have yet to be developed.

For the most part, portable electronic devices in a particular category of goods (e.g., mobile telephones) are about the same size. Similarly, portable electronic devices in a particular subcategory of goods (e.g., mini-laptop computers) are each about the same size. However, currently, portable electronic devices of a particular category (or subcategory) of goods do not have a standard shape. This is true, not only for portable electronic devices that are made by different manufacturers, it even applies to different models made by the same manufacturer. For example, Apple's iPhone® 2G mobile telephone has a different shape than Apple's iPhone® 3G mobile telephone.

Due to the different shapes of portable electronic devices, stands for such devices have generally had to be designed for each individual device. Accordingly, when a consumer upgrades from one portable electronic device (Apple's iPhone® 2G mobile telephone) to another portable electronic device (Apple's iPhone® 3G mobile telephone), the consumer has generally been required to purchase a new stand (if available) for the upgraded device.

In view of the above, there is a need to develop stands for portable electronic devices that accommodate devices having differing shapes and/or sizes.

### SUMMARY OF THE INVENTION

The present invention is designed to address at least one of the aforementioned problems and/or meet at least one of the aforementioned needs.

In one embodiment, a universal stand for portable electronic devices is disclosed. The stand includes a display platform with a gripping surface for releasably securing a portable electronic device thereto. In one embodiment, the display platform pivots to allow a user to adjust the orientation of the portable electronic device relative to the user.

Other objects, features, embodiments and advantages of the invention will be apparent from the following specification taken in conjunction with the following drawings.

### BRIEF DESCRIPTION OF THE DRAWINGS

FIG. 1 is a perspective view of one exemplary embodiment of a stand of the present invention;

FIG. 2 is an exploded perspective view of the embodiment of the stand shown in FIG. 1, but from a different angle and showing an exemplary portable electronic device;

FIG. 3 is a side view of the embodiment of the stand shown in FIG. 1, wherein the stand is attached to a non-horizontal surface, such as a windshield;

FIG. 4 is a side view of the embodiment of the stand shown in FIG. 1, wherein the stand is attached to a horizontal surface, such as a desktop;

FIG. 5 is a side view of the embodiment of the stand shown in FIG. 1, which illustrates exemplary ranges of motion of both the arm relative to the base and the display platform relative to the arm in phantom;

FIG. 6 is a view taken along line 6-6 of FIG. 5;

FIG. 7 is a side view of the arm of the embodiment shown in FIG. 1;

FIG. 8 is a view taken along line 8-8 of FIG. 7;

FIG. 9 is side view, opposite to the side view shown in FIG. 7, of the arm of the embodiment shown in FIG. 1;

FIG. 10 is a perspective view of the base of the embodiment shown in FIG. 1;

FIG. 11 is an exploded perspective view of the base shown in FIG. 10;

FIG. 12 is a side view of the base of the embodiment shown in FIG. 1;

FIG. 13 is a view taken along line 13-13 of the base shown in FIG. 12;

FIG. 14 is a side view, opposite to that shown in FIG. 12, of the base;

FIG. 15 is an exploded perspective view of the display platform of the embodiment shown in FIG. 1;

FIG. 16 is plan view of the display platform shown in FIG. 15;

FIG. 17 is an end view of the display platform shown in FIG. 15;

FIG. 18 is side view of the base prior to it being attached to a surface;

FIG. 19 is a cross-sectional view taken along the centerline of the base shown in FIG. 18;

FIG. 20 is a cross-sectional view, similar that shown in FIG. 19, with an arrow showing pressure being applied to the base, so that it contacts the surface to which it will become removably attached;

FIG. 21 is a side view, similar to that shown in FIG. 18, showing the lever of the base in a depressed position, such that the base assembly is in engagement with the surface via its suction cup assembly;

FIG. 22 is a cross-sectional view taken along the centerline of the base assembly shown in FIG. 21;

FIG. 23 is partial cross-sectional view taken along line 23-23 of FIG. 22, which introduces the arm, threaded knob, nut and nut cover prior to threading the screw portion of the knob into the nut;

FIG. 24 is a view similar to that shown in FIG. 23, wherein the screw portion of the knob has been threaded into the nut;

FIG. 25 is a partial sectional view of the display platform, which illustrates the ball and socket joint in an engaged configuration;

FIG. 26 is a side view of another exemplary embodiment of the present invention, wherein an adhesive is used to connect the base to a surface and wherein a film is shown that is peeled-off to expose the adhesive;

FIG. 27 is partial side view of the embodiment shown in FIG. 26, wherein the base is connected to a surface by the adhesive;

FIG. 28 is a partial side view of another embodiment of the present invention, wherein screws are used to removeably attach the base to a surface;

FIG. 29 is section view taken along line 29-29 of FIG. 28;

FIG. 30 is a side view, similar to that shown in FIG. 3, of another exemplary embodiment of the stand, wherein the stand does not include a ball-and-socket joint;

FIG. 31 is a side view, similar to that shown in FIG. 3, of another exemplary embodiment of the stand, wherein the arm does not pivot relative to the base;

FIG. 32 is a side view, similar to that shown in FIG. 3, of another exemplary embodiment of the stand, wherein the stand does not include a ball-and-socket joint and wherein the arm does not pivot relative to the base;

FIG. 33 is front view of the stand of FIG. 1, which illustrates the display platform in a portrait configuration in solid lines and in a landscape configuration in phantom;

FIG. 34 is a perspective view of the stand of FIG. 1, along with an exemplary plate to which the stand has been attached;

FIG. 35 is a perspective view of an exemplary embodiment of a surface gripping pad, wherein the top surface of the surface gripping pad includes dimples;

FIG. 36 is a perspective view of the surface gripping pad of FIG. 35, wherein the bottom surface of the surface gripping pad does not include dimples;

FIG. 37 is a perspective view of the stand of FIG. 1, which has been attached to the gripping pad of FIG. 35;

FIG. 38 is a side view of an exemplary base;

FIG. 39 is a front view of the base of FIG. 38;

FIG. 40 is a side view of another exemplary base;

FIG. 41 is a front view of base of FIG. 40;

FIG. 42 is a perspective view of yet another exemplary base;

FIG. 43 is an exploded perspective view of another embodiment of a stand of the present invention and illustrates a different spring location than that shown in FIGS. 11 and 18-24;

FIGS. 44 and 45 are views similar to those shown in FIGS. 19 and 22, respectively, and illustrate the spring location for the embodiment of the stand shown in FIG. 43;

FIG. 46 is an exploded perspective view (similar to FIG. 15) of another embodiment of a display platform including a platform body and a gripping pad;

FIG. 47 is a front view of the platform body shown in FIG. 46;

FIG. 48 is a perspective view of the platform body shown in FIG. 46;

FIG. 49 is a magnified view that illustrates a portion of the platform body shown in FIG. 48;

FIGS. 50-60 illustrate various views of a first embodiment of a semi-spherical stand;

FIGS. 61-71 illustrate various views of a first lanyard-based stand;

FIGS. 72-90 illustrate various views of a stand that may be used when tethering a portable electronic device to a computer or another item;

FIGS. 91-103 illustrate various views of a game wheel stand;

FIG. 104 is a front view of a platform body having a plurality of protrusions, which assist in attaching the gripping pad thereto;

FIG. 105 is a cross-sectional view along lines 105-105 of FIG. 104 of the platform body just prior to it being placed into contact with a molten gripping pad material that is held in a mold;

FIG. 106 is a view similar to FIG. 105, except that the platform body has been placed into contact with the molten gripping pad material that is being held by the mold;

FIG. 107 is a view similar to FIG. 106, except that the gripping pad material is attached to the platform body, has cured and has been removed from the mold;

FIG. 108 is a cross-sectional view of a first embodiment of an intermediate plate just prior to it being placed into contact with a molten gripping pad material that is held in a mold;

FIG. 109 is a view similar to FIG. 108, except that the intermediate plate has been placed into contact with the molten gripping pad material that is being held by the mold;

FIG. 110 is a view similar to FIG. 108, except that the gripping pad material is attached to the intermediate plate, has cured and has been removed from the mold, and the intermediate plate has been attached to the platform body;

FIG. 111 is a cross-sectional view of a second embodiment of an intermediate plate;

FIG. 112 is a cross-sectional view of the second embodiment of the intermediate plate after the gripping pad material has cured and is attached to the intermediate plate;

FIG. 113 is a cross-sectional view of a third embodiment of an intermediate plate;

FIG. 114 is a cross-sectional view of the third embodiment of the intermediate plate after the gripping pad material has cured and is attached to the intermediate plate;

FIG. 115 is a cross-sectional view of a fourth embodiment of an intermediate plate;

FIG. 116 is a cross-sectional view of the fourth embodiment of the intermediate plate after the gripping pad material has cured and is attached to the intermediate plate;

FIG. 117 is an isometric view of gripping pad material in liquid form being poured onto a piece of mesh material;

FIG. 118 is a cross-sectional elevational view of a gripping pad, after curing, attached to the mesh;

FIG. 119 is an isometric view of the gripping pad and mesh combination after it has been sewn to a fabric or other material;

FIG. 120 is an isometric view of a gripping pad that has been sewn to a fabric or other material without a piece of mesh material;

FIG. 121 is a cross-sectional view of a gripping pad that has been bonded to a piece of mesh material using an adhesive;

FIG. 122 is a front view of a gripping pad with suction cups;

FIG. 123 is a side view taken along line 123-123 of FIG. 122;

FIG. 124 is a view similar to FIG. 15;

FIG. 125 is a sectional view taken along line 125-125 of FIG. 124;

FIGS. 126-128 illustrate various views of a second embodiment of a semi-spherical stand;

FIGS. 129-139 illustrate various views of a third embodiment of a semi-spherical stand;

FIGS. 140-143 illustrate various views of a second embodiment of a lanyard-based stand;

FIGS. 144-147 illustrate various views of a third embodiment of a lanyard-based stand, which includes a protective cover for the gripping pad;

FIGS. 148-149 illustrate various views of a fourth embodiment of a lanyard-based stand, which includes a protective case;

FIGS. 150-151 illustrate various views of a fifth embodiment of a lanyard-based stand;

FIGS. 152-154 illustrate various views of a sixth embodiment of a lanyard-based stand;

FIGS. 155-160 illustrate various views of a second embodiment of a stand that may be used when tethering a portable electronic device to a computer or other item;

FIG. 161 illustrates a stand that has been attached to a disk (similar to FIG. 34);

FIG. 162 illustrates a front view of the disk of FIG. 161 with a surface gripping pad adhered to the bottom of the disk;

FIGS. 163-167 illustrate various views of an exemplary stand with a v-shaped handle;

FIGS. 168-170 illustrate various views of an exemplary stand with a pistol-grip type handle;

FIGS. 171-173 illustrate various views of an exemplary stand with a handlebar type handle; and,

FIGS. 174-178 illustrate various views of a compact-type universal stand.

### DETAILED DESCRIPTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspects of the invention to the embodiments illustrated.

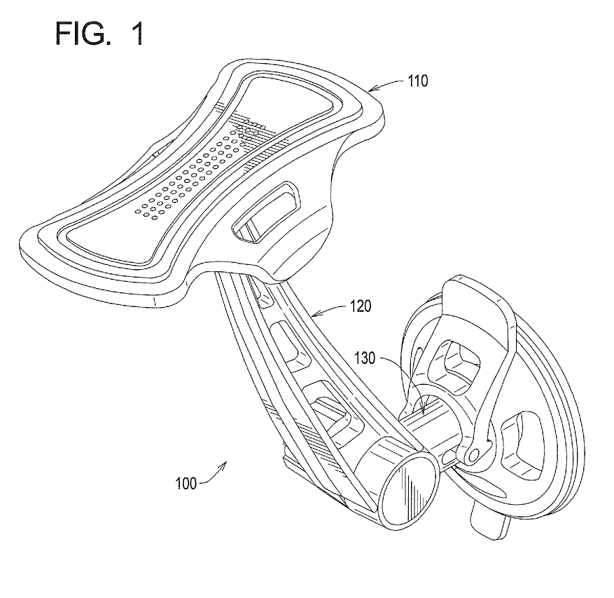

A first embodiment of a stand 100 for a portable electronic device is illustrated in FIG. 1. The stand 100 includes a display platform 110, an arm 120 and a base 130.

It should be understood that FIG. 1 illustrates one embodiment of an exemplary stand and that, in other embodiments, one or more of the display platform 110, arm 120 or base 130 may be eliminated. Furthermore, in other embodiments, one or more of the illustrated features of the display platform 110, arm 120 or base 130 (if present) may be eliminated or modified.

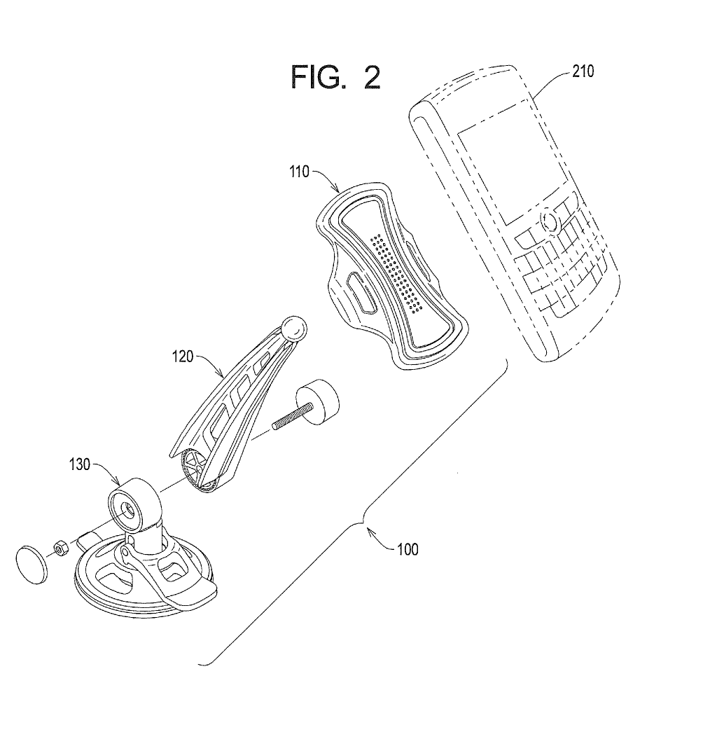

FIG. 2 is an exploded perspective view of the embodiment of the stand 100 shown in FIG. 1, but from a different angle than that shown in FIG. 1. In addition, FIG. 2 shows an exemplary portable electronic device 210 (in phantom) which may be used with the stand 100.

As will be discussed in more detail when referring to the other figures contained herein, the stand 100 permits adjustment of the viewing angle of the portable electronic device 210 via a ball-and-socket joint formed between the display platform 110 and the arm 120 and/or via a pivot point formed between the arm 120 and the base 130.

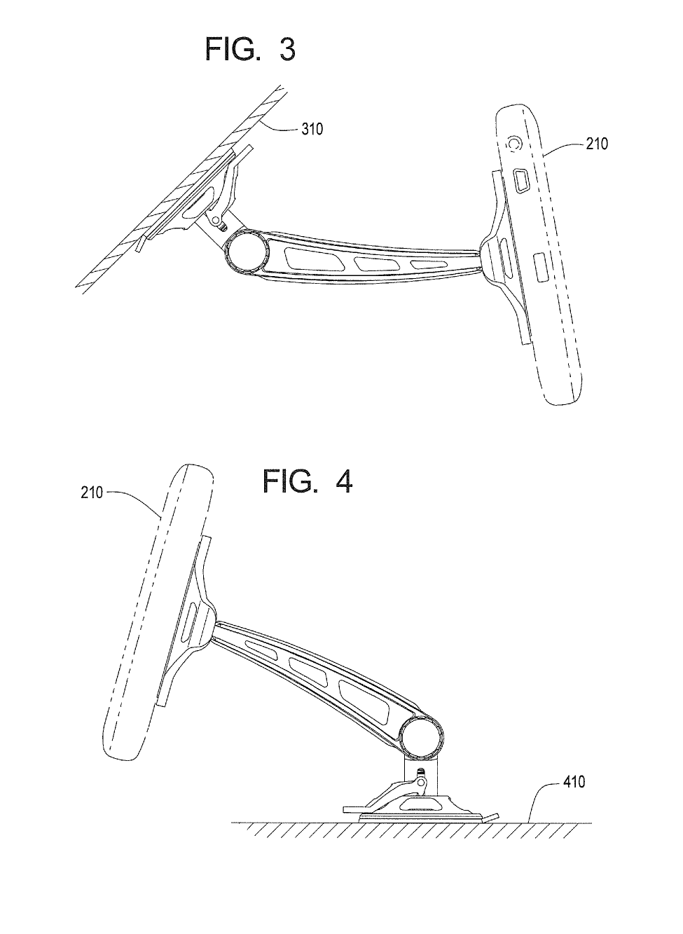

FIG. 3 is a side view of the embodiment of the stand 100 shown in FIG. 1. As shown in FIG. 3, the stand 100 is attached to a non-horizontal surface 310, such as a windshield. Of course, attachment to other non-horizontal surfaces is possible and anticipated. For example, the non-horizontal surface 310 may be a window, wall, interior panel of a vehicle, arm of a chair, cabinet or side of a desk, among other things.

FIG. 4 is a side view of the embodiment of the stand 100 shown in FIG. 1. As shown in FIG. 4, the stand 100 is attached to a horizontal surface 410, such as a desktop. Of course, attachment to other horizontal surfaces (or substantially horizontal surfaces) is possible and anticipated. For example, the horizontal surface 410 may be a plate, vehicle dashboard, vehicle console, interior portion of vehicle moon roof, interior portion of vehicle sunroof, countertop or seat of a chair, among other things.

With reference again to FIGS. 3 and 4, it should be understood that the non-horizontal surface 310 of FIG. 3 and the horizontal surface of FIG. 4 do not necessarily have to be flat surfaces. For example, the surfaces can be contoured, curved, grooved, rough or bumpy, among other things. In one embodiment, instead of using a suction cup to attach to such surfaces, a polyurethane gel or similar pad (see infra) may be included as part of the base, so as to potentially enhance attachment to such surfaces.

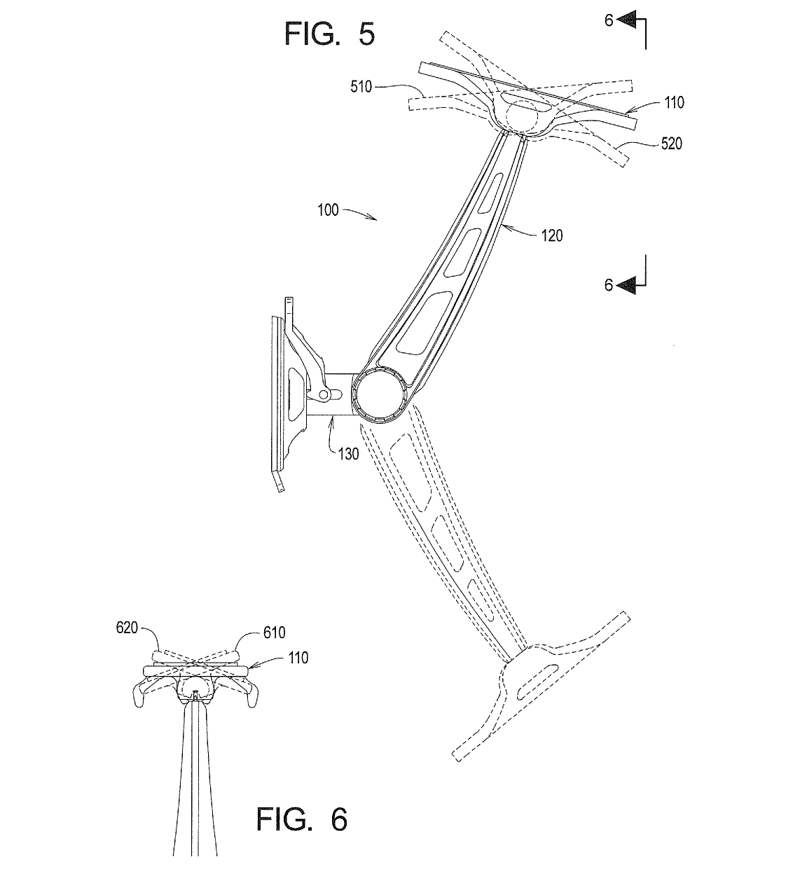

FIG. 5 is a side view of the embodiment of the stand 100 shown in FIG. 1. Specifically, FIG. 5 illustrates exemplary ranges of motion of both the arm 120 relative to the base 130 and the display platform 110 relative to the arm 120 in phantom.

As shown in FIG. 5, the arm 120 pivots about an axis perpendicular to the page. The range of motion of the arm 120 relative to the base 130 is about 140 degrees. This range represents the number of degrees between a position of the arm 120 like that which is shown in solid lines and a position of the arm 120 like that which is shown in phantom lines. (Note: FIG. 5 does not show the exact range of motion.) It should be understood that the stand 100 can be designed for other ranges of motion of the arm 120 relative to the base 130 and that such ranges are anticipated.

With respect to the range of motion of the display platform 110 relative to the arm 120, FIG. 5 is limited to showing exemplary pitch angles. The range of pitch angles may be provided relative to a neutral position of the display platform 110, which is represented by the display platform in solid lines. In one embodiment, the maximum pitch angle of the display platform 110, when tilted in a counterclockwise direction through an axis perpendicular to the page to a position 510, is approximately 25 degrees relative to the neutral position. In one embodiment, the maximum pitch angle of the display platform 110, when tilted in a clockwise direction through an axis perpendicular to the page to a position 520, is approximately 25 degrees relative to the neutral position. Of course, the stand 100 can be designed for other pitch angle ranges and such ranges are anticipated.

FIG. 6 is a view taken along line 6-6 of FIG. 5 and illustrates the range of motion of the display platform 110 relative to the arm 120, but is limited to showing exemplary yaw angles. The range of yaw angles may be provided relative to a neutral position of the display platform 110, which is represented by the display platform 110 in solid lines. In one embodiment, the maximum yaw angle of the display platform 110, when tilted in a counterclockwise direction through an axis perpendicular to the page to a position 610, is approximately 28 degrees relative to the neutral position. In one embodiment, the maximum yaw angle of the display platform 110, when tilted in a clockwise direction through an axis perpendicular to the page to a position 620, is approximately 28 degrees relative to the neutral position. Of course, the stand 100 can be designed for other yaw angle ranges and such ranges are anticipated.

As will be understood after viewing FIGS. 1-6, in one embodiment, the ball and socket joint permits the display platform (and, hence, the portable electronic device) to be rotated 360 degrees (i.e., 360 degree roll). In one embodiment, the portable electronic device may be rotated at least 180 degrees. In one embodiment, the portable electronic device may be rotated at least 90 degrees (see FIG. 33, wherein the display platform is illustrated in a portrait configuration in solid lines and wherein the display platform is illustrated in a landscape configuration in phantom). Other angles of rotation are possible and are anticipated.

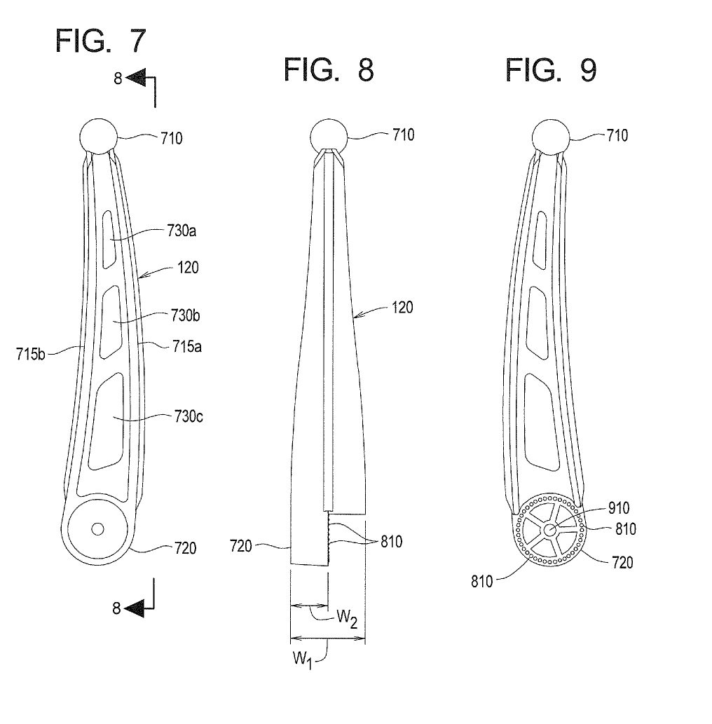

FIG. 7 is a side view of the arm 120 of the embodiment shown in FIG. 1. Arm 120 includes a ball 710, which cooperates with a socket (not shown in FIG. 7) in display platform 110 to form a ball-and-socket joint.

In another embodiment, the ball and socket are reversed. That is, the display platform includes a ball and the arm includes a socket.

As shown in FIG. 7, arm 120 is slightly curved. In one embodiment, the radius of curvature is different between a top portion 715a of the arm 120 and a bottom portion 715b. In one embodiment, the radius of curvature of the top portion 715a of the arm 120 is approximately 17½ inches and the radius of curvature of the bottom portion 715b of the arm 120 is approximately 20 inches. Of course, it is anticipated that the radius of curvature of the top portion 715a and the bottom portion 715b of the arm 120 may be different from the radii set forth above (e.g., they may vary by ±10 inches). In one embodiment, the arm 120 is not curved, but straight.

FIG. 7 illustrates an arm connection member 720, which is used to connect the arm 120 to the base 130, as will be described in further detail with reference to other figures. The arm connection member 720 assists the arm 120 in pivoting relative to the base 130.

The arm 120 includes first aperture 730a, second aperture 730b and third aperture 730c. The first aperture 730a is closest to the ball-and-socket joint and is smaller than both the second aperture 730b and the third aperture 730c. The second aperture 730b is between the first aperture 730a and the third aperture 730c, and is larger than the first aperture 730b, but smaller than the third aperture 730c. The third aperture 730c is furthest from the ball-and-socket joint and is larger that both the first aperture 730a and the second aperture 730c. In one embodiment, the arm 120 does not include one or more of apertures 730a, 730b, 730c.

FIG. 8 is a view taken along line 8-8 of FIG. 7. FIG. 8 illustrates projections 810 of the arm connection member 720. In one embodiment, the projections 810 have a hemispherical shape. However, it should be understood that the projections 810 can take on many other shapes. For example, the projections 810 can have a block shape or peak (sawtooth) shape.

As shown in FIG. 8, the arm 120 has a maximum width w1. In one embodiment, the maximum width w1 of the arm 120 is near the end of the arm 120 which is opposite to the ball-and-socket joint. In one embodiment, the arm connection member 720 has a width w2 that is less than the maximum width w1 of the arm 120. In one embodiment, the width w2 of the connection member is about half the maximum width w1 of the arm 120. In one embodiment, the projections 810 lie approximately along a centerline formed along the length of the arm 120.

FIG. 9 is side view, opposite to the side view shown in FIG. 7, of the arm of the embodiment shown in FIG. 1. FIG. 9 illustrates the placement of the projections 810 about the arm connection member 720. In one embodiment, the projections 810 are placed in a generally circular shape about the arm connection member 720. In one embodiment, the projections 810 are placed in a polygonal shape about the arm connection member 720.

In one embodiment, the arm 120 pivots relative to base 130 through a pivot point 910 that is located at the center of the generally circular shape formed by the placement of the projections 810. In one embodiment, the arm 120 pivots relative to base 130 through a pivot point that is located at the centroid of the generally polygonal shape formed by the placement of the projections 810.

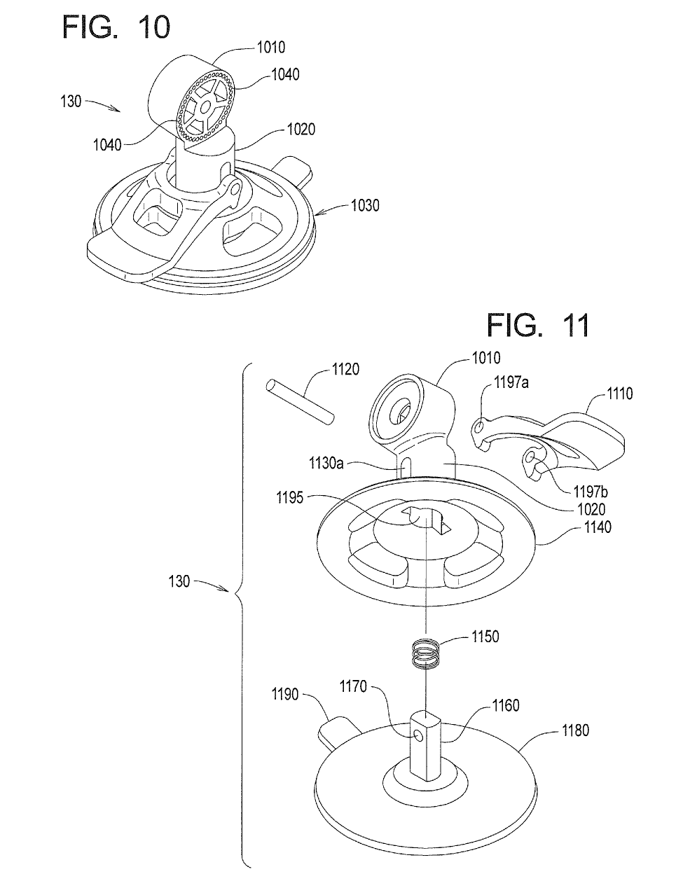

FIG. 10 is a perspective view of the base 130 of the embodiment shown in FIG. 1. In one embodiment, the base 130 includes a base connection member 1010, a shaft 1020 and a suction cup assembly 1030.

The base connection member 1010 includes recesses 1040 that correspond in shape and placement with projections 810 of the arm connection member 720. For example, the recesses 1040 are circularly shaped, so as to receive hemispherical projections 810, and the recesses 1040 are placed in a generally circular shape about the base connection member 1010.

FIG. 11 is an exploded perspective view of the base 130 shown in FIG. 10. The base 130 includes base connection member 1010, shaft 1020 and suction cup assembly 1030. In one embodiment, suction cup assembly 1030 includes lever 1110, pin 1120, slots 1130a, 1130b (only one of which is shown), suction cup cover 1140, spring 1150, plunger 1160, opening 1170, suction cup 1180 and suction cup tab 1190. Shaft 1020 includes cavity 1195, while lever 1110 includes holes 1197a and 1197b.

With reference to FIGS. 10 and 11, after the base 130 has been constructed, the spring 1150 and plunger 1160 lie within cavity 1195. The spring 1150 exerts a force on the top of the plunger 1160, so as to bias the plunger 1160 in a direction towards its bottom (i.e., towards suction cup 1180). Furthermore, pin 1120 lies within hole 1197a, slot 1130a, opening 1170, slot 1130b (not shown) and hole 1197b. In addition, suction cup cover 1140 is adjacent to suction cup 1180.

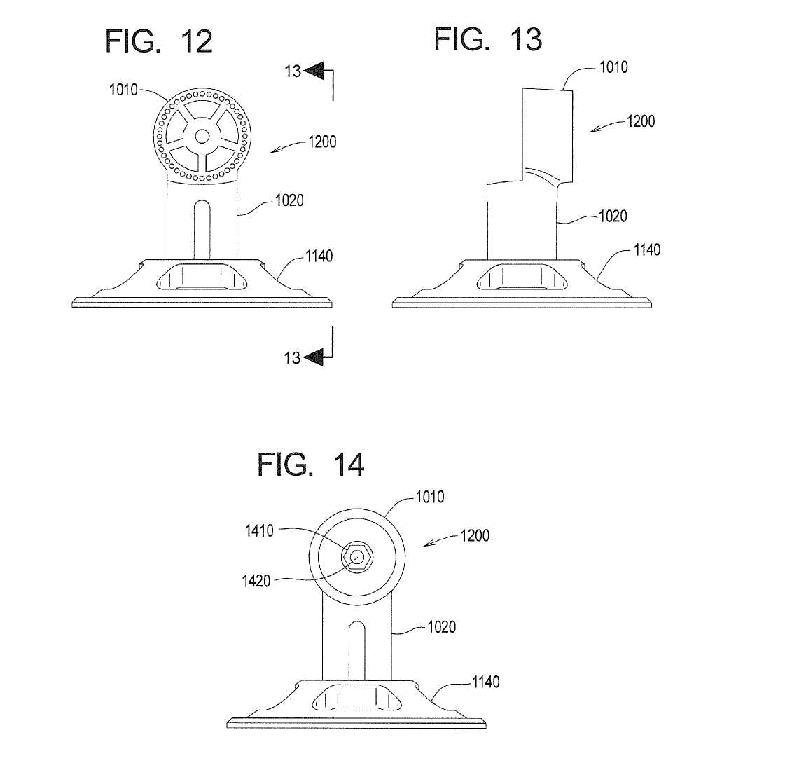

FIG. 12 is a side view of a base assembly 1200 of the embodiment shown in FIG. 1. The base assembly 1200 includes the base connection member 1010, shaft 1020 and suction cup cover 1140. The base assembly 1200 may be molded as a single piece.

FIG. 13 is a view taken along line 13-13 of the base assembly 1200 shown in FIG. 12. FIG. 13 illustrates the position of the base connection member 1010 relative to the shaft 1020 for one embodiment of the present invention.

FIG. 14 is a side view, opposite to that shown in FIG. 12, of the base assembly 1200. FIG. 14 illustrates a nook 1410 for receiving a polygon-shaped nut and an orifice 1420 for receiving a screw that threads into the polygon-shaped nut (not shown). The shape of the nook 1410 holds the nut in place while the screw is threaded into the nut.

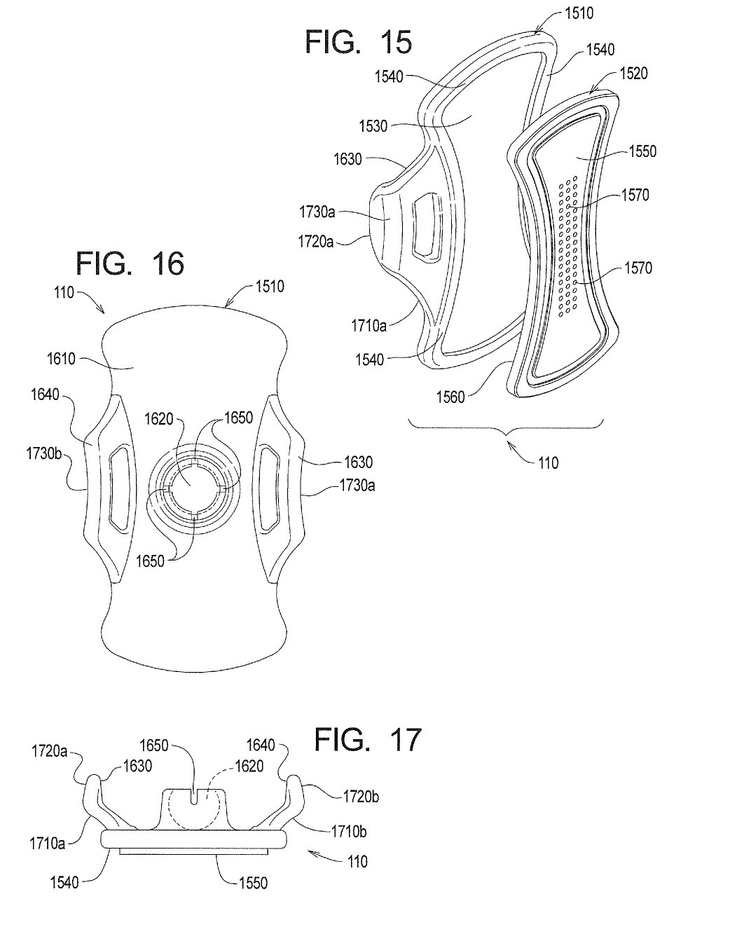

FIG. 15 is an exploded perspective view of the display platform 110 of the embodiment shown in FIG. 1. The display platform 110 includes a platform body 1510 and a gripping pad 1520.

The platform body 1510 has a face 1530 with a raised border 1540. The gripping pad 1520 attaches to the face 1530 of the platform body 1510 and its edges lie inside the raised border 1540. As shown in FIG. 15, the shape of the edges of the gripping pad 1520 are approximately the same as the shape of the raised border 1540.

In one embodiment, the gripping pad 1520 is made of molded polyurethane (also known as PU Gel). PU Gel is quite sticky. Therefore, when a portable electronic device is placed into contact with the gripping pad 1520, it can securely grip such portable electronic device.

PU Gel is sold by Shenzhen Diya Silicone Co. Ltd. of Shenzhen, China (www.szdiya.com) as Part No. ANT-004. Another supplier of PU Gel is Henwei Industrial Co., Ltd. of Ningbo, China (www.nbhenda.com).

The gripping pad 1520 has a front 1550 and a back 1560. The back 1560 of the gripping pad 1520 has a shape that corresponds to the shape of the face 1530 of the platform body 1510. In the embodiment shown in FIG. 15, the back 1560 of the gripping pad 1520 is flat, smooth and continuous, so as to maximize the contact surface area between the back 1560 of the gripping pad 1520 and the face 1530 of the platform body 1510. Accordingly, it is very difficult to remove the gripping pad 1520 from the platform body 1510.

The front 1550 of the gripping pad 1520 is designed to grip a portable electronic device. While it is important that a strong grip be maintained when a portable electronic device is suspended, the portable electronic device should be able to be removed from the gripping pad 1520 upon application of reasonable force. Accordingly, the front 1550 of the gripping pad 1520 includes dimples 1570 for reducing the contact surface area between it and the portable electronic device, so that a portable electronic device can be removed therefrom using reasonable force. Thus, by adjusting the contact surface area of the front 1550 or back 1560 of the gripping pad 1520, the force required to disengage an object from the gripping pad (or, conversely, the gripping pad from an object) can be adjusted.

It should be understood that, in certain applications, it may be desirable for a portable electronic device to form a semi-permanent or permanent connection with the gripping pad 1520. In such case, there may not be a need for a significant reduction (e.g., through use of dimples 1570) in the contact surface area of the front 1550 of the gripping pad 1520. In one embodiment, the contact surface area between the back 1560 of the gripping pad 1520 and the face 1530 of the platform body 1510 is reduced (e.g., through use of dimples 1570).

In one embodiment, the contact surface area of the front 1550 of the gripping pad 1520 is less than the contact surface area of the back 1560 of the gripping pad 1520. In one embodiment, in addition to or in place of dimples 1570, the contact surface area of the front 1550 of the gripping pad 1520 is reduced by providing a pattern thereon (e.g., perforations, cross-hatching, grooves or some other pattern).

In one embodiment, the gripping pad 1520 may be made of expanded vinyl, as described in U.S. Pat. No. 6,673,409 to Wheatley. As described therein, the expanded vinyl material may include diisodecy/phlthalate, polymeric plasticer, a UV stabilizer, a vinyl heat stabilizer, a blowing agent for vinyl plastisol and vinyl resin (plastic).

As also described in U.S. Pat. No. 6,673,409, in one embodiment, the gripping pad 1520 is formed of different layers with different materials. For example, the gripping pad 1520 can have a skin layer on its bottom surface, which is formed of a material that is different than the rest of the pad. For example, the material of the skin layer (identified by reference numeral 40 in the aforementioned patent) can include aqua ammonia (NH₄OH), azardine, rubber, color and body for thickening. In one embodiment, the gripping pad 1520 is formed out of silicone.

FIG. 16 is rear plan view of the display platform 110 shown in FIG. 15. Specifically, FIG. 16 illustrates the back 1610 of the platform body 1510, which includes a socket 1620, first wing 1630 and second wing 1640.

As alluded to above, the display platform 110 and the arm 120 are connected by a ball and socket joint. Accordingly, the display platform 110 may be pivoted about an infinite number of axes relative to the arm 120.

In one embodiment (see FIGS. 2 and 7-9), ball 710 is attached to or forms part of the arm 120. In one embodiment, socket 1620 is attached to or forms part of the display platform 110. It should be understood that, in other embodiments, the ball may be attached to or form part of the display platform 110 or the base 130. Furthermore, in other embodiments, the socket may be attached to or form part of the arm 120 or the base 130.

In one embodiment, the ball 710 (see, again, FIGS. 2 and 7-9) and socket 1620 (see FIG. 16) are removably connected. In one embodiment, the socket 1620 includes one or more expansion channels 1650. The one or more expansion channels 1650 permit the connection between the ball 710 and socket 1620 to be made efficiently. In addition, the one or more expansion channels 1650 are believed to aid in the removable connection of the ball 710 and socket 1620. Although four expansion channels 1650 are shown in the FIG. 16, as few as one and as many as ten expansion channels are contemplated and anticipated. In one embodiment, no expansion channels are provided. Furthermore, although all expansion channels 1650 are shown to be the same size in FIG. 16, expansion channels of differing sizes are contemplated and anticipated.

FIG. 17 is an end view of the display platform 110 shown in FIG. 15. Among other things, FIG. 17 shows that first wing 1630 includes an extension member 1710a and a finger grip 1720a, while second wing 1640 includes an extension member 1710b and a finger grip 1720b.

Extension members 1710a and 1710b extend away from a plane parallel to the main portion of the face 1530 at an angle of about 45 degrees. Other angles are contemplated and anticipated. In one embodiment, the angle is between a range of greater than or equal to 0 degrees and less than or equal to 90 degrees relative to the plane. In one embodiment, the angle is between a range of 20 degrees to 70 degrees.

Finger grips 1720a and 1720b extend away from a plane parallel to the main portion of the face 1530 at an angle of about 90 degrees relative to the plane. Other angles are contemplated and anticipated. In one embodiment, the angle is between a range of greater or equal to 0 degrees and less than or equal to 90 degrees.

In one embodiment, finger grips 1720a and 1720b extend towards a plane parallel to the main portion of the face 1530 at an angle having a range greater than or equal to 0 degrees and less than or equal to 90 degrees. Other angles are contemplated and anticipated.

In one embodiment, the extension members 1710a and 1710b and the finger grips 1720a and 1720b cooperate with one another to provide sufficient clearance to allow a user to adjust the angle (e.g., pitch, yaw and/or roll) of the display platform 110. A user may, for example, adjust the angle of the display platform by placing his right thumb on finger grip 1720a and his right forefinger and/or middle finger on finger grip 1720b. As shown in FIGS. 15 and 16, a portion of the finger grips 1720a, 1720b may each have a curved or saddle shape 1730a, 1730b (or a plurality of curved or saddle shapes), so as to assist a user in engaging the finger grips 1720a, 1720b.

It should be understood that the extension member 1710a may have a different size and shape from extension 1710b. Likewise, finger grip 1720a may have a different size and shape from finger grip 1720b.

FIG. 17 shows that the front 1550 of the gripping pad 1520 extends beyond a plane formed by the raised border 1540 of the face 1530. Accordingly, the front 1550 of the gripping pad 1520 is presented to a portable electronic device for engagement thereto.

In one embodiment, the front 1550 of the gripping pad 1520 is contoured so as to receive portable electronic devices that are similarly contoured.

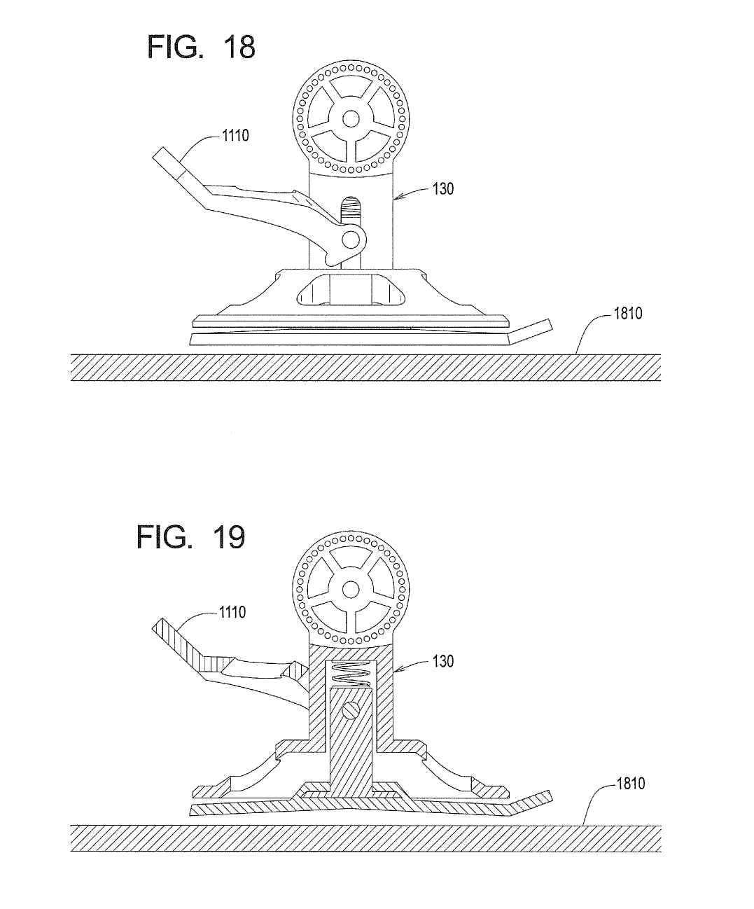

Although the suction cup assembly 1030 used herein is considered to be well-known, FIGS. 18-22 are used to briefly illustrate how the base 130 is removably attached to surface 1810 using suction cup assembly 1030.

FIG. 18 is side view of the base 130 prior to it being attached to a surface 1810. Accordingly, lever 1110 is in an initial (non-depressed) position. As mentioned above, the surface 1810 may include, but is not limited to, a window, wall, interior panel of a vehicle, arm of a chair, cabinet, side of a desk, plate, vehicle dashboard, vehicle console, interior portion of vehicle moon roof, interior portion of vehicle sunroof, countertop or seat of a chair. FIG. 19 is a cross-sectional view taken along the centerline of the base 130 shown in FIG. 18.

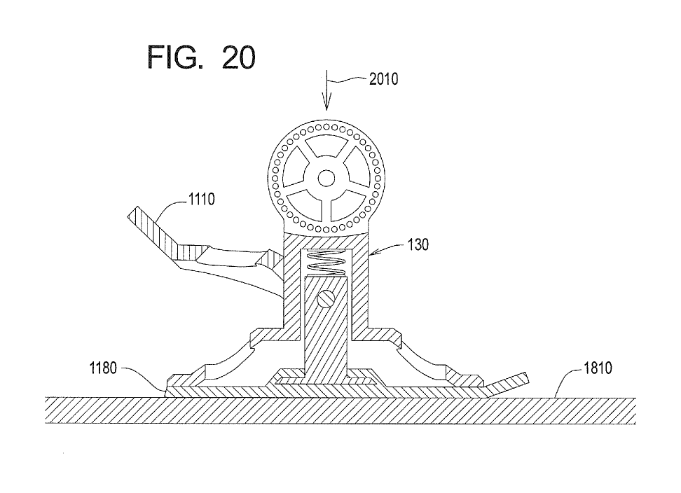

FIG. 20 is a cross-sectional view, similar that shown in FIG. 19, with an arrow 2010 showing the direction in which force is being applied to the base 130. The force causes a significant portion of the surface area of suction cup 1180 to be placed into contact with the surface 1810.

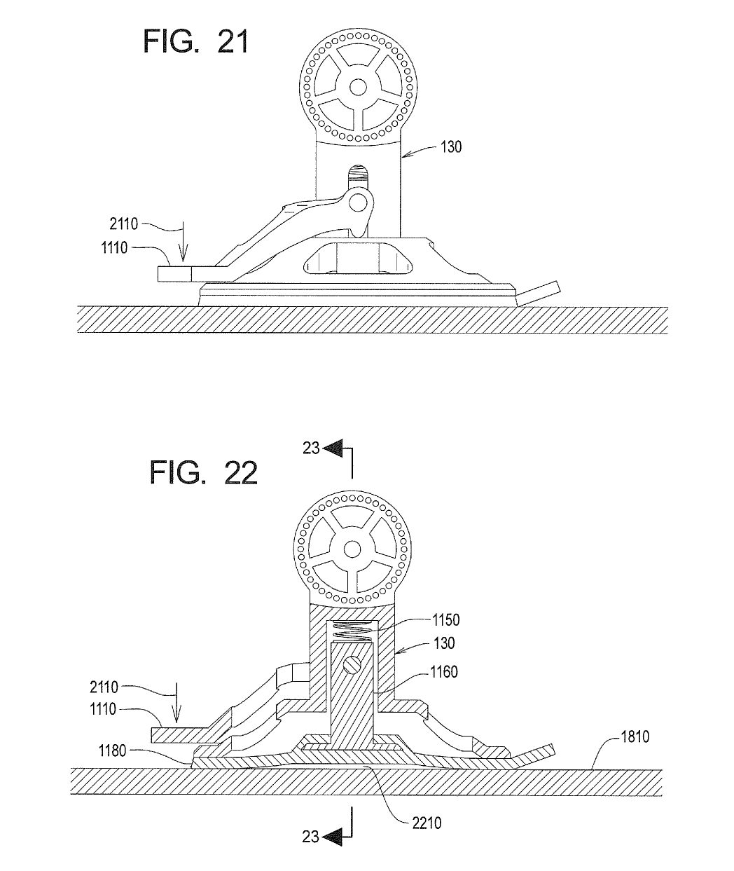

FIG. 21 is a side view, similar to that shown in FIG. 18, showing the lever 1110 of the base 130 in a depressed position. Arrow 2110 shows the general direction in which force was applied to move the lever 1110 into a depressed position.

FIG. 22 is a cross-sectional view taken along the centerline of the base assembly shown in FIG. 21. When lever 1110 is moved from its initial position to a depressed position, plunger 1160 is moved in a direction towards spring 1150 (thereby compressing the spring further) which causes suction cup 1180 to lift away from surface 1810. A negative pressure is created in a gap 2210 between suction cup 1180 and surface 1810, so that suction cup 1180 (and, hence, base 130) becomes attached to the surface 1810.

To detach the suction cup 1180 from the surface 1810, the lever 1110 is moved from its depressed position towards its initial position. This causes plunger 1160 to move in a direction away from the spring 1150, thereby reducing the negative pressure between the suction cup 1180 and the surface 1810.

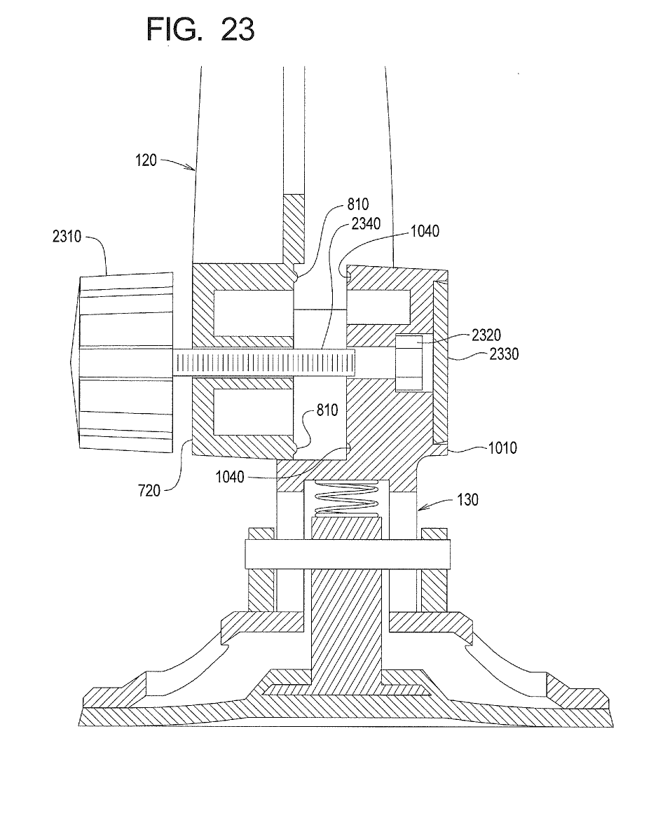

FIG. 23 is partial cross-sectional view taken along line 23-23 of FIG. 22, but further including the arm 120, threaded knob 2310, nut 2320 and nut cover 2330. The threaded knob 2310 includes a screw portion 2340.

In the embodiment shown in FIG. 23, the arm 120 pivots relative to the base 130 along an axis through the center of the screw portion 2340 of threaded knob 2310. The position of the arm 120 relative to the base 130 is adjusted and locked into place using the projections 810 of arm connection member 720, the recesses 1040 of base connection member 1010, threaded knob 2310, nut 2320 and screw portion 2340 of threaded knob 2310. FIG. 23 is an illustration prior to threading the screw portion 2340 of the knob 2310 into the nut 2320.

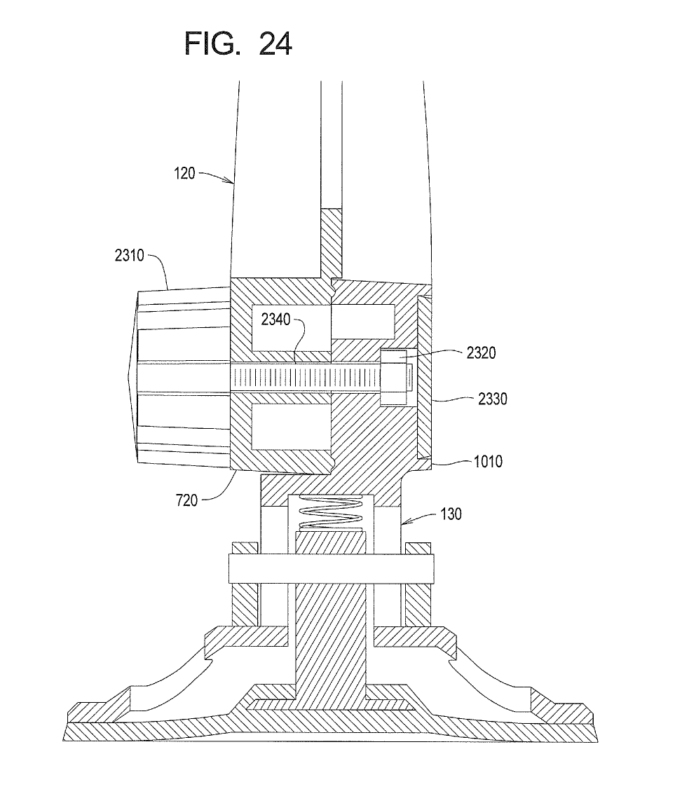

FIG. 24 is a view similar to that shown in FIG. 23, wherein the screw portion 2340 of the threaded knob 2310 has been threaded into the nut 2320 and wherein protrusions 810 engage recesses 1040 (shown, but not labeled), so that the position of the arm 120 is locked relative to the base 130.

In order to pivot the arm 120 relative to the base 130, the threaded knob 2310 is turned, so that its screw portion 2340 is partially (or completely) withdrawn from nut 2320. Then, a user then disengages the protrusions 810 from the recesses 1040 by pulling the arm connection member 720 and the base connection member 1010 in opposite directions relative to an axis through the center of screw portion 2340 of the threaded knob 2310.

Next, the user pivots the arm 120 relative to the base 130. When the arm 120 is at approximately the correct location, the user pushes the arm connection member 720 and the base connection member 1010 towards one another. Because the protrusions 810 and the recesses 1040 may not necessarily be in alignment, the user may have to slightly pivot the arm connection member 720 and the base connection member 1010 relative to one another while pushing them together. Finally, the threaded knob 2310 is turned is so as to thread the screw portion 2340 of the threaded knob 2310 into the nut 2320.

The nut cover 2330 reduces the opportunity for dust and other particulates to interfere with the interaction between the nut 2320 and the screw portion 2340 of the threaded knob 2310. Nut cover 2330 also may make the device more aesthetically pleasing, as the nut 2320 (or a portion thereof) is not exposed. Although nut 2320 is held in place by an adhesive or other technique, the nut cover 2330 may also prevent the nut 2320 from becoming lost if the nut 2320 becomes dislodged.

In one embodiment, the nut 2320 and the screw portion 2340 of the threaded knob 2310 are designed so that they do not come apart from each other (at least, not very easily). That is, once the nut 2320 and the screw portion 2340 of the threaded knob 2310 become engaged, the screw portion 2340 may only be withdrawn up to a predetermined amount (e.g., by altering the thread of the screw portion 2340). By doing so, the likelihood of the threaded knob 2310 becoming lost is reduced.

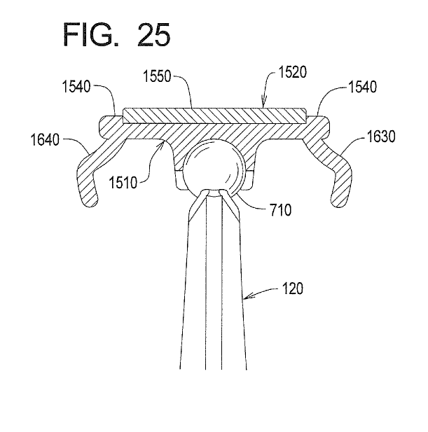

FIG. 25 is a partial sectional view of the stand 100 of FIG. 1 which illustrates the ball and socket joint in an engaged configuration. FIG. 25 also demonstrates that the front 1550 of the gripping pad 1520 extends beyond a plane formed by the raised border 1540 of the face 1530. Accordingly, the front 1550 of the gripping pad 1520 is presented to a portable electronic device for engagement thereto.

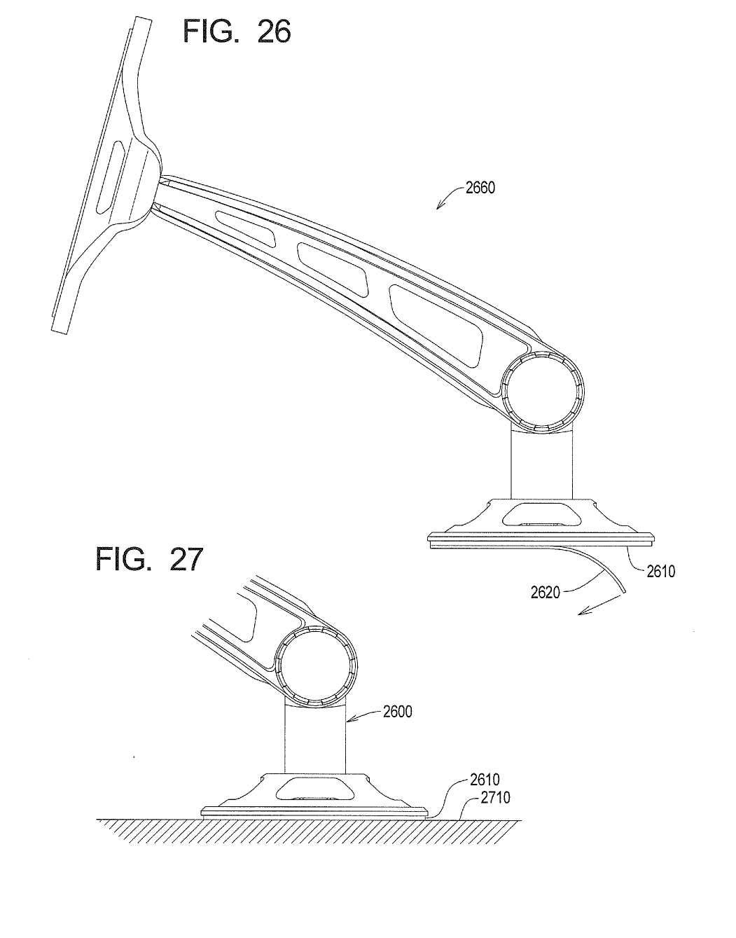

FIG. 26 is a side view of another exemplary embodiment of a stand of the present invention. In contrast to stand 100 of FIG. 1, stand 2600 includes a foot 2610 instead of a suction cup assembly 1030 to attach its base to a surface.

In the embodiment shown in FIG. 26, the foot 2610 has an adhesive material thereon. A film 2620 covers the adhesive material until it is ready to be applied to a surface to which the stand is to be attached.

In one embodiment, the foot 2610 may be made of rubber. In one embodiment, the foot 2610 may be made of PU Gel.

FIG. 27 is partial side view of the embodiment shown in FIG. 26, wherein the stand 2600 is attached to a surface 2710 using the adhesive material. It should be noted that using the adhesive material would create a substantially permanent connection between the stand 2600 and the surface 2710. Therefore, using PU Gel (or expanded vinyl or silicone) may be advantageous, since the stand 2600 could be removably connected to the surface 2710, as will be understood by those skilled in the art in view of the discussion above in connection with gripping pad 1520.

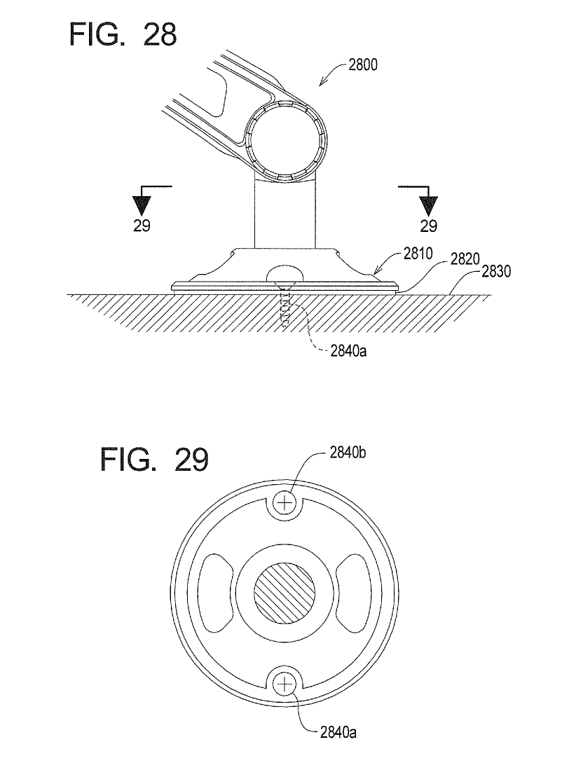

FIG. 28 is a partial side view of another exemplary embodiment of a stand of the present invention. In contrast to stand 100 of FIG. 1, stand 2800 includes an attachment assembly 2810 instead of a suction cup assembly 1030 to attach its base to a surface.

Attachment assembly 2810 includes rubber pad 2820 to mate with surface 2830. Attachment assembly 2810 also includes screws 2840a, 2840b to removeably attach the stand 2800 to surface 2830. The screws 2840a, 2840b may be screwed directly into the surface 2830 or into a receiving member (e.g., a threaded screw receiving member).

FIG. 29 is section view taken along line 29-29 of FIG. 28. FIG. 29 illustrates the position of screws 2840a, 2840b. Although two screws are shown, it should be understood that the stand can include one screw or more than two screws.

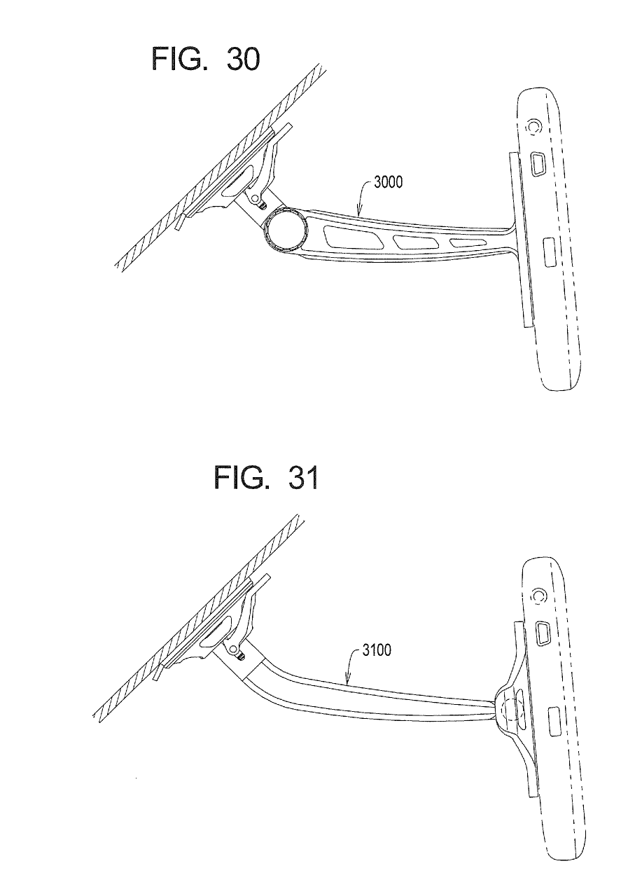

FIG. 30 is a side view, similar to that shown in FIG. 3, of another exemplary embodiment of a stand. In contrast to stand 100 of FIG. 1, stand 3000 does not include a ball-and-socket joint.

FIG. 31 is a side view, similar to that shown in FIG. 3, of another exemplary embodiment of a stand. In contrast to stand 100 of FIG. 1, stand 3100 does not include an arm that pivots relative to a base.

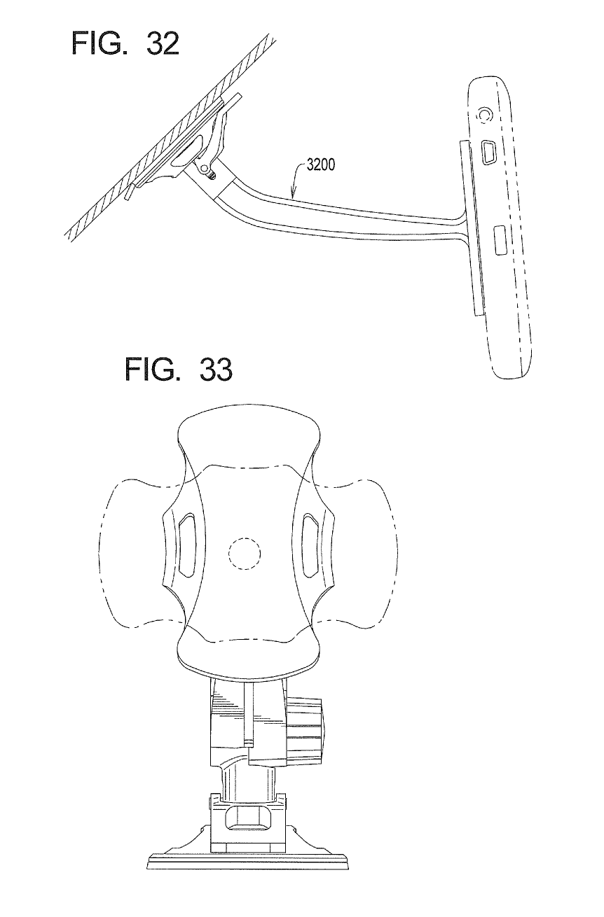

FIG. 32 is a side view, similar to that shown in FIG. 3, of another exemplary embodiment of a stand. In contrast to stand 100 of FIG. 1, stand 3200 does not include a ball-and-socket joint and does not include an arm that pivots relative to a base.

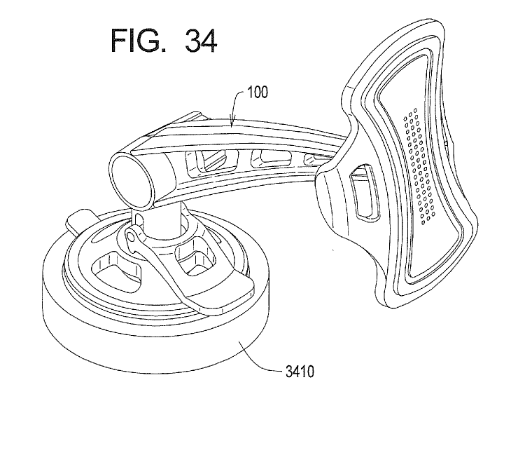

FIG. 34 is a perspective view of the stand of FIG. 1. FIG. 34 also illustrates an exemplary plate 3410 to which the stand 100 has been attached.

In some cases, the stand's suction cup may have difficulty in attaching to a surface. In one embodiment, the plate 3410 is provided to which the stand 100 can be attached. In one embodiment, the plate 3410 is heavy enough, so that the stand will not tip (or tip over) when a portable electronic device is being supported thereby.

In one embodiment, the plate 3410 is lightweight and made of plastic, and includes an adhesive on its bottom for attaching to a surface. In one embodiment, a double-sided adhesive tape is used to attach the plate 3410 to a surface.

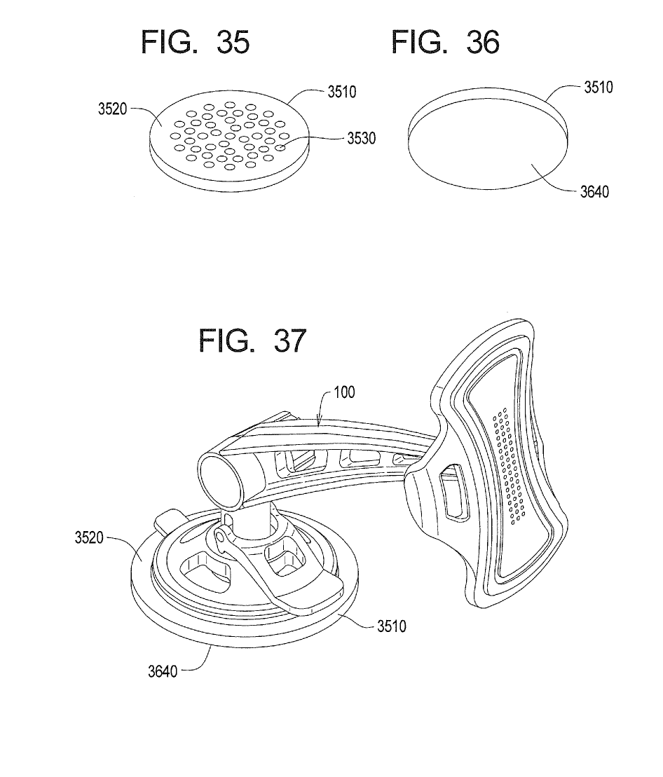

In one embodiment, instead of (or in addition to) using a plate like plate 3410, a surface gripping pad 3510 (see FIG. 35) is provided. FIG. 35 is a perspective view of an exemplary embodiment of a surface gripping pad.

The surface gripping pad 3510 includes a top surface 3520, which has dimples 3530 therein. In one embodiment, the surface gripping pad 3510 is made of PU Gel and the dimples 3530 are used to reduce the contact surface area of top surface 3520 of the surface gripping pad 3510, so that the force required to detach an item therefrom is reduced as compared to a top surface 3520 without dimples 3530.

FIG. 36 is a perspective view of the surface gripping pad 3510 of FIG. 35. The surface gripping pad 3510 has a bottom surface 3640. In one embodiment, the bottom surface 3640 of the surface gripping pad 3510 does not include dimples.

In one embodiment, the top surface 3520 and the bottom surface 3640 of the surface gripping pad 3510 are flat, smooth and continuous. In one embodiment, the top surface 3520 and the bottom surface 3640 of the surface gripping pad 3510 have approximately the same contact surface area and do not include dimples 3530.

FIG. 37 is a perspective view of the stand 100 of FIG. 1. As shown in FIG. 37, the stand 100 has been attached to the top surface 3520 of the surface gripping pad 3510. The bottom surface 3640 of the surface gripping pad 3510 is attached (or to be attached) to a surface (not shown).

In one embodiment, the surface gripping pad 3510 has a thickness that is equivalent to the thickness of the gripping pad 1520 of the stand 100. In one embodiment, the thickness of both the surface gripping pad 3510 and the gripping pad 1520 is one-eighth (⅛) of an inch. In one embodiment, the thickness of the gripping pad 1520 is different from the thickness of the surface gripping pad 3510.

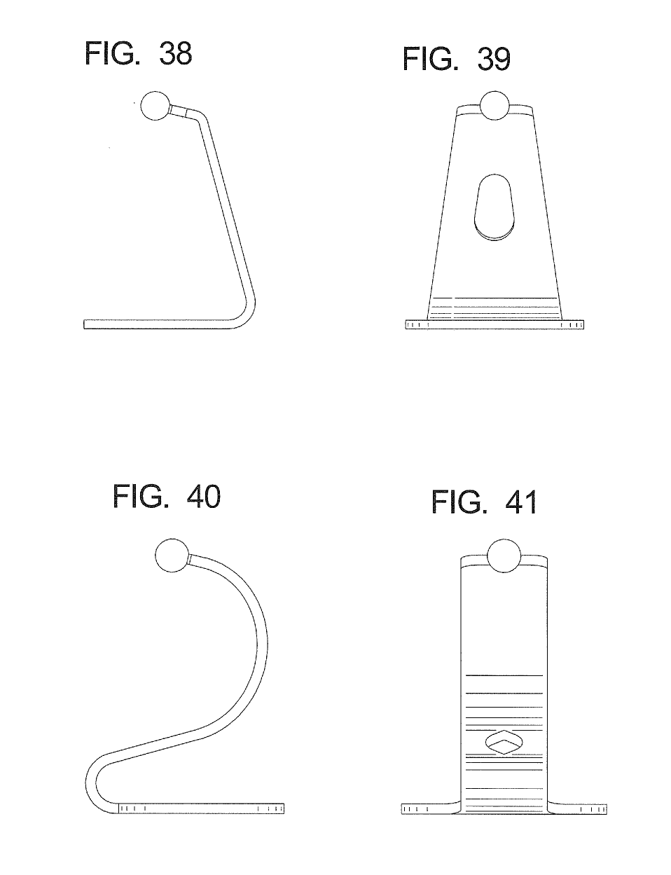

The display platform 110 illustrated, for example, in FIGS. 15-17 may be used with the bases shown and described in U.S. patent application Ser. No. 12/287,260. Three of the bases that are illustrated in such patent application are shown in FIGS. 38-42 herein.

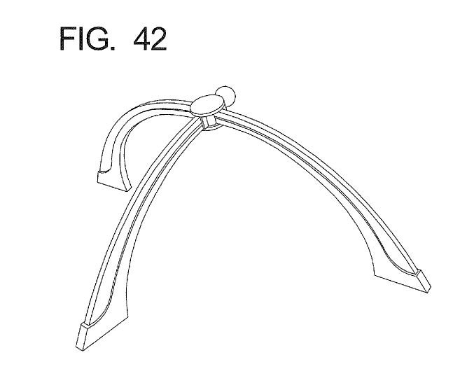

FIG. 38 is a side view of a first exemplary base and FIG. 39 is a front view of the base of FIG. 38. FIG. 40 is a side view of another exemplary base and FIG. 41 is a front view of base of FIG. 40. FIG. 42 is a perspective view of yet another exemplary base.

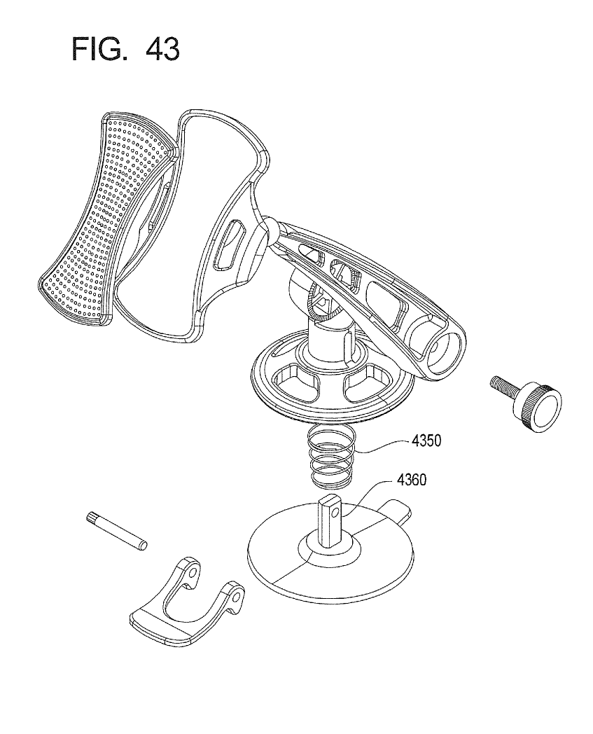

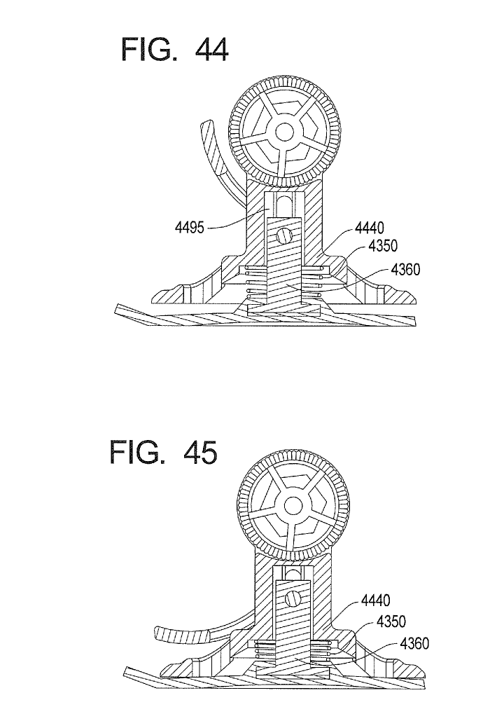

FIG. 43 is an exploded perspective view of another embodiment of a stand of the present invention and illustrates a different spring location than that shown in FIGS. 11 and 18-24. FIGS. 44 and 45 are views similar to those shown in FIGS. 19 and 22, respectively, and illustrate the spring location for the embodiment of the stand shown in FIG. 43.

Specifically, as shown in FIGS. 43-45, the spring 4350 does not rest on top of the plunger 4360. Instead, the spring 4350 has a large enough diameter, such that it fits around the plunger 4360. Accordingly, the spring 4350 engages the suction cup cover 4440 and is not received within cavity 4495.

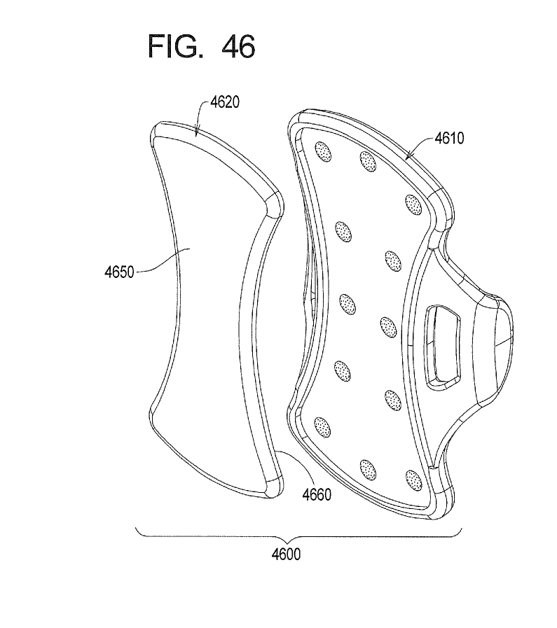

FIG. 46 is an exploded perspective view (similar to FIG. 15) of another embodiment of a display platform 4600 including a platform body 4610 and a gripping pad 4620. In contrast to the gripping pad 1520 shown in FIG. 15, both the front 4650 and the back 4660 of the gripping pad 4620 are flat, smooth and continuous. That is, neither the front 4650 nor the back 4660 of the gripping pad 4620 include dimples 1570 (or the like) to reduce their contact surface area.

In one embodiment, the gripping pad 4620 is made of PU Gel. In order to achieve the required stickiness for suspending a portable electronic device, the mixing ratio of the PU Gel's part-A and part-B components is adjusted.

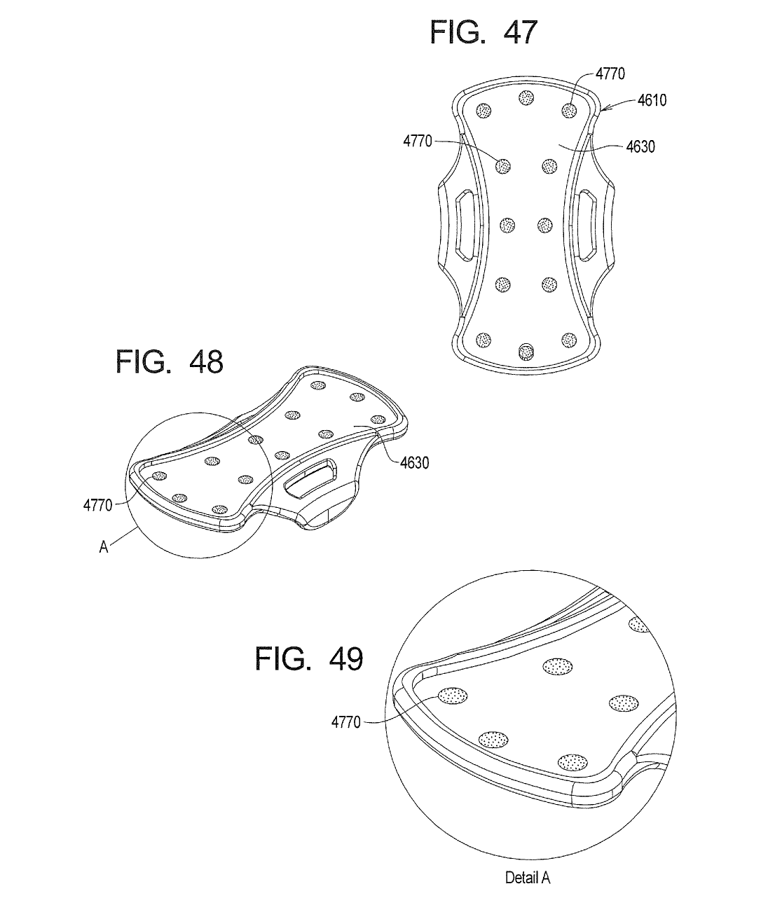

FIG. 47 is a front view of the platform body 4610 shown in FIG. 46. FIG. 48 is a perspective view of the platform body 4610 shown in FIG. 46. FIG. 49 is a magnified view that illustrates a portion of the platform body 4610 shown in FIG. 48.

As shown in FIGS. 46-49, the platform body 4610 has a face 4630 to which gripping pad 4620 attaches. The face 4630 of the platform body 4610 includes one or more textured areas 4770. The one or more textured areas 4770 are created using appropriate tooling in an injection molding process.

In one embodiment, the one or more textured areas 4770 are approximately flush with the main portion of the face 4630. In one embodiment, the one or more textured areas 4770 are slightly recessed relative to the main portion of the face 4630. In one embodiment, the one or more textured areas 4770 are raised relative to the main portion of the face 4630.

Instead of solely relying on the stickiness of the gripping pad 4620 to attach the gripping pad 4620 to the platform body 4610, one or more adhesives may also be used. This increases the likelihood that the platform body 4610 and the gripping pad 4620 will remain permanently connected.

In one embodiment, a primer is applied to the one or more textured areas 4770 of the platform body 4610 prior to applying an adhesive. In one embodiment, the primer is Loctite 770, which is available from Henkel Corporation (www.loctite.com). In one embodiment, the primer is an Aliphatic amine and the solvent is n-Heptane. In one embodiment, the primer has a very low viscosity. In one embodiment, the primer is applied with a brush or a swab. In one embodiment, the primer is applied as a mist using a sprayer.

After the primer has been applied, an adhesive is applied to the one or more textured areas 4770 of the platform body 4610. In one embodiment, the adhesive is applied approximately 60 seconds after the primer has been applied. In one embodiment, the adhesive is Loctite 401, which is available from Henkel Corporation (www.loctite.com). In one embodiment, the adhesive is an Ethyl cyanoacrylate. In one embodiment, one or more small drops of adhesive are applied to the one or more textured areas 4770.

After the adhesive has been applied, the back 4660 of the gripping pad 4620 is immediately placed into contact with the face 4630 of the platform body 4610 with even pressure applied over the entire front surface 4650 of the gripping pad 4620 for approximately 30-60 seconds. In one embodiment, if a tool is used to apply pressure to the front surface 4650 of the gripping pad 4620, the surface of the tool that contacts the gripping pad 4620 is selected from one or more materials such that the gripping pad 4620 does not stick thereto and/or is textured in such a way that the gripping pad 4620 does not stick thereto. In one embodiment, the non-glued surface of the gripping pad 4620 may also have a non-stick film applied to it (as mentioned above) to prevent (or reduce) unwanted sticking during the process of applying pressure after gluing.

It should be understood that other primers or adhesives may be used. The primer and adhesive discussed above are effective in gluing a gripping pad 4620 made of PU Gel to a platform body 4610 made of Polyacetal (e.g., Delrin). If other materials were used, the primer and/or adhesive might change. In one embodiment, instead of using cyanoacrylate adhesives, epoxies, urethane adhesives and/or adhesive double-sided tapes may be used.

The one or more textured areas 4770 are not limited to those shown in the figures. It should be understood that fewer or more textured areas may be used. Furthermore, the size of the textured areas may greater than or less than the size shown in the figures. In one embodiment, the textured area may be a continuous thin line that follows the outer edge of the face 4630 of the platform body 4610.

In one embodiment, the surface area of the gripping surface of the gripping pad is smaller than the surface area of the entirety of the surface of the portable electronic device that is releasably secured to the gripping pad. For example, if the back of the portable electronic device is releasably secured to the gripping pad, then the surface area of the (front) gripping surface of the gripping pad is less than the total surface area of the back of the portable electronic device.

In one embodiment, the surface to which the stand is attached is not smooth. In one embodiment, the base of the stand is contoured to correspond to the shape of such surface. In one embodiment, the base (or arm) of the stand is inserted into a receiving member in a vehicle's dashboard and is locked into place. In one embodiment, a button is pressed to release the stand from the vehicle's dashboard.

In one embodiment, multiple portable electronic devices may be received by the stand. In one embodiment, multiple gripping pads are provided to releasably secure the multiple portable electronic devices. In one embodiment, multiple portable electronic devices are releasably secured to a single gripping pad.

In one embodiment, a backing layer is provided when shipping the stand, so that nothing unintentionally sticks to the gripping pad.

In one embodiment, the gripping pad may be cleaned by using soap and water. In one embodiment, the gripping pad is cleaned using tap water, without soap. In one embodiment, the gripping pad is cleaned using a damp Polyvinyl Alcohol (PVA) sponge or similar material. In one embodiment, the gripping pad is cleaned using a “lint-free” microfiber cloth.

In one embodiment, the platform body 1510 is made of ABS and the socket is made of Delrin. In this case, the socket is screwed into the back of the platform body. This embodiment may be useful, as ABS is considered an easier material to which to apply an adhesive (e.g., glue), so as to secure the gripping pad to the platform body.

In one embodiment, an intermediate plate is made of ABS and is screwed to a platform body made of Delrin. Again, this allows adhesive to be more easily applied for purposes of securing the gripping pad to the platform body.

In one embodiment, the curved arm has an axis through which it pivots. Thus, the axis (pivot point) is fixed relative to the base. However, because the ball-and-socket permits, among other things, 360 degree rotation of the display platform, the curvature of the arm may be used to advantageously position the stand by appropriate positioning of the base. Compare, for example, FIG. 3 to FIG. 4.

In FIG. 3, the curvature of the arm is concave-up relative to the bottom of the page. The base could be mounted under a mirror and the curvature of the arm may be advantageously used to give the stand clearance from the mirror.

In FIG. 4, the curvature of the arm is concave-down relative to the bottom of the page. The base could be mounted on a vehicle dashboard and the curvature of the arm may be advantageously used to give the stand clearance from the dashboard.

In one embodiment, a ball and socket connection is made between the arm and the base to provide additional degrees of freedom therebetween. In such case, a locking mechanism (not shown) is used to lock the position of the arm relative to the base. As an example, the locking mechanism may include one or more screws that are placed into frictional contact with the ball once the desired orientation of the arm and base has been reached, so that the arm and base do not move relative to one another.

In one embodiment, the portable electronic device may include a cover and/or a case. For example, in one embodiment, the cover may be clear, like the invisibleSHIELD cover sold by ZAGG, Inc. of Salt Lake City, Utah (www.zagg.com). In one embodiment, the shape of the gripping pad substantially corresponds to the shape of the cover.

In one embodiment, the platform body 1510 is made of polyacetal, namely, Delrin®. In one embodiment, the suction cup 1180 is thermoplastic rubber elastomer. In one embodiment, the gripping pad 1520 is made of polyurethane gel. In one embodiment, most of the other components are made of Nylon 6.

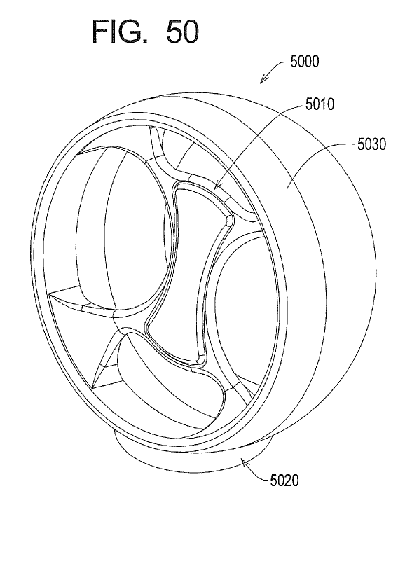

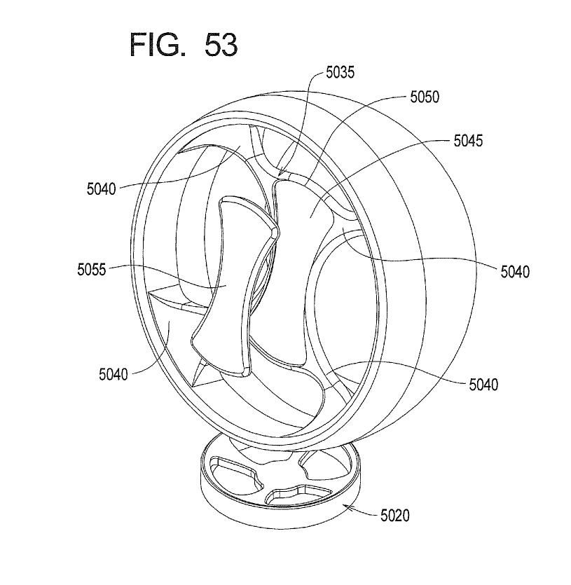

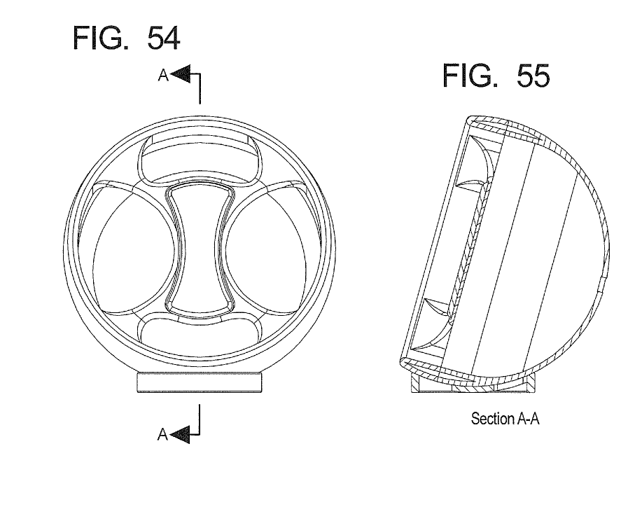

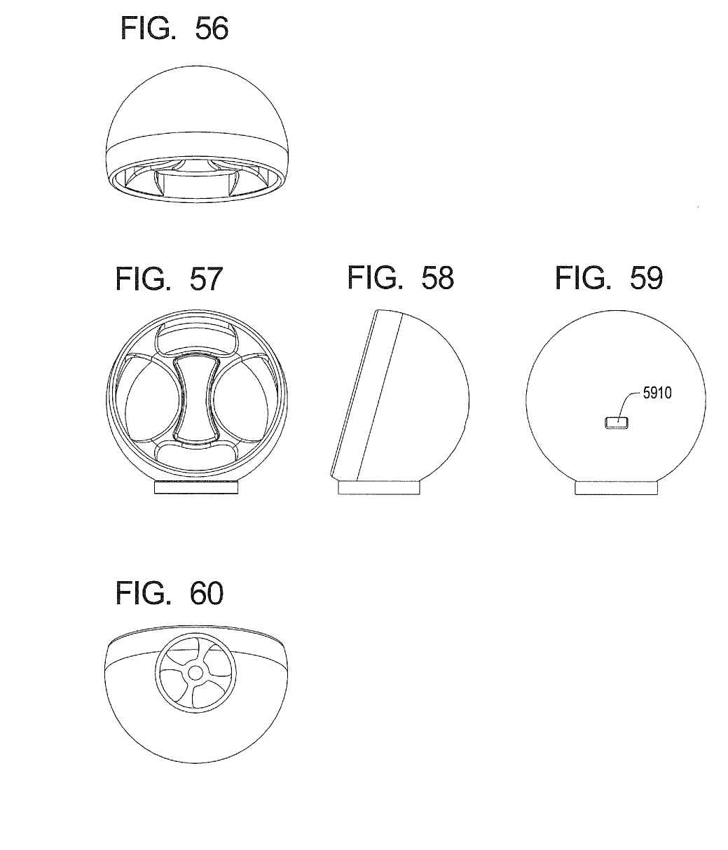

FIGS. 50-60 illustrate various views of a semi-spherical stand 5000. The semi-spherical stand 5000 includes a display platform 5010 and a base 5020. The display platform 5010 has a semi-spherical housing 5030 and a platform body 5035, which may be integrally connected to one another by arms 5040.

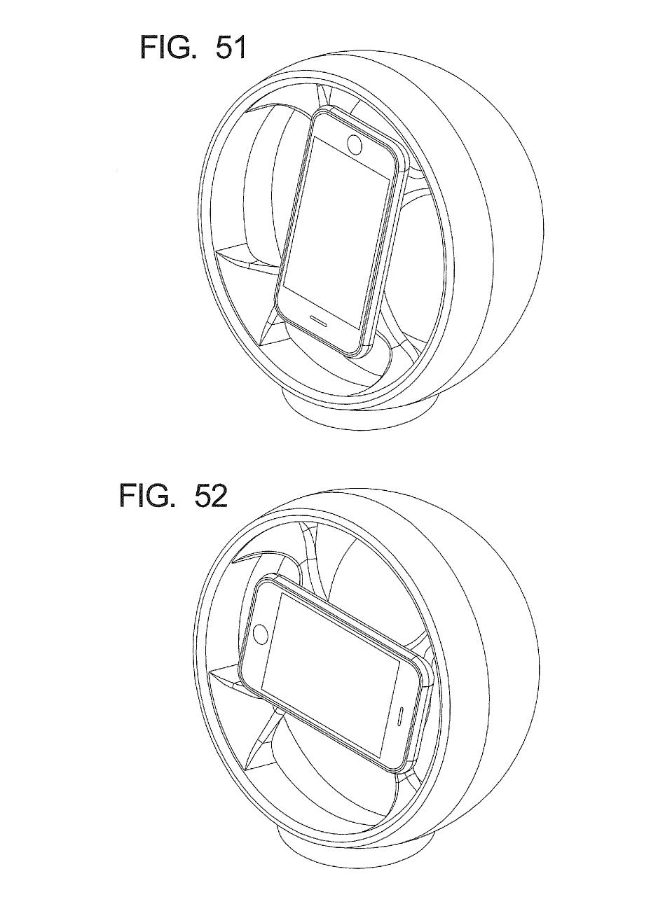

The platform body 5035 includes a face 5045 with a border 5050. A gripping pad 5055 attaches to the face 5045 of the platform body 5035 and its edges lie within the border 5050. As shown in FIGS. 51 and 52, the gripping pad 5055 may be used to suspend a portable electronic device.

In one embodiment, the semi-spherical housing 5030 is substantially hollow. In one embodiment, the portable electronic device includes speakers and the semi-spherical housing magnifies the sound generated by the speakers. In one embodiment, by altering the shape of the interior of the semi-spherical housing and/or by adjusting the depth of the display platform within the housing, sound amplification may be improved and/or sound quality may be enhanced.

The display angle of the portable electronic device may be modified by changing the position of the display platform 5010 relative to the base 5020.

In one embodiment, the housing 5030 includes an aperture 5910 therein (see FIG. 59). The aperture 5910 permits passage of a cable (not shown) therethrough. The cable may be attached to a portable electronic device that is suspended by the gripping pad 5055, so as to charge the portable electronic device.

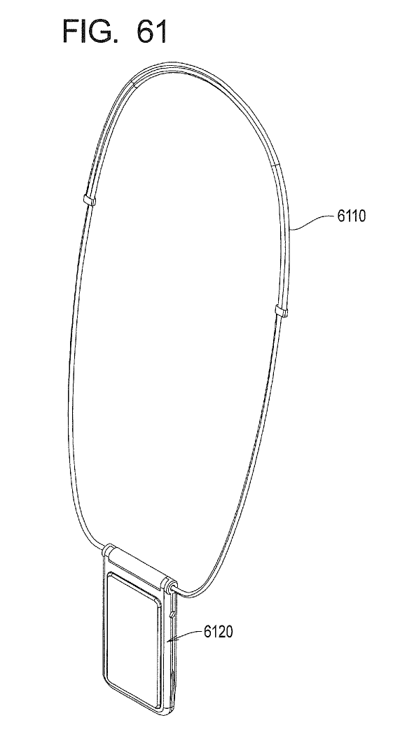

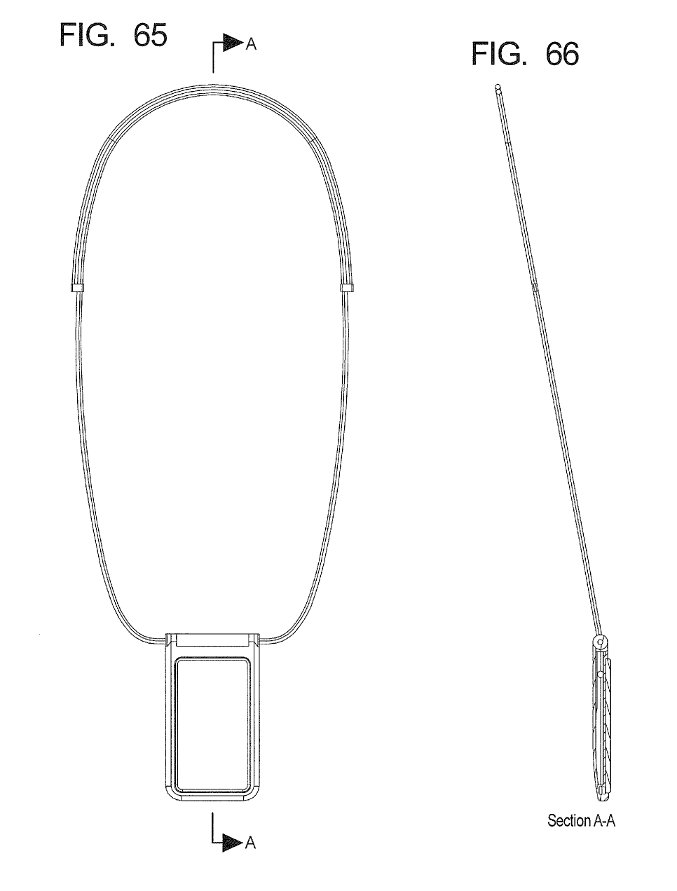

FIGS. 61-71 illustrate various views of a lanyard-based stand. The lanyard-based stand includes a neckstrap 6110 and a display platform 6120 that is attached thereto. In one embodiment, the neckstrap 6110 is adjustable.

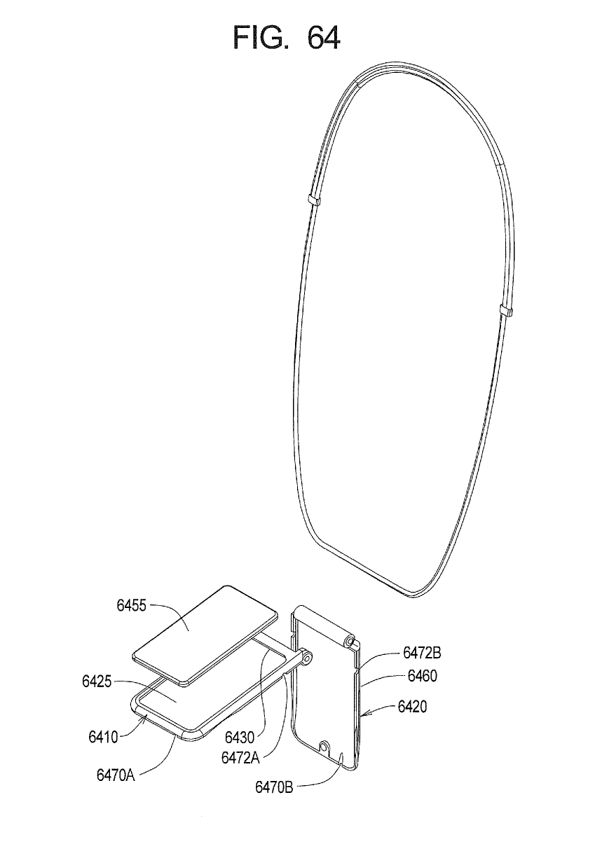

With reference to FIG. 64, the display platform 6120 includes a front plate (or platform body) 6410 and a back plate 6420. The front plate 6410 includes a face 6425 with a border 6430.

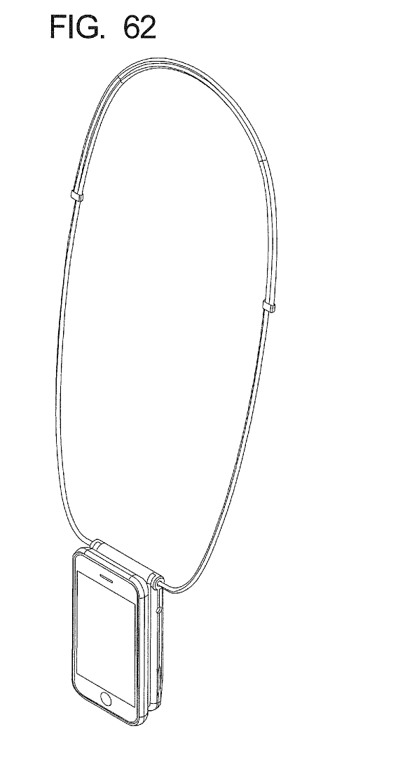

A gripping pad 6455 attaches to the face 6425 of the front plate 6410 and its edges lie within the border 6430. As shown in FIG. 62, the gripping pad 6455 may be used to suspend a portable electronic device. In one embodiment, the portable electronic device is suspended upside down (opposite to that shown in FIG. 62), so that a user can easily rotate and lift the portable electronic device to a right-side-up viewing angle. In one embodiment, the back 6460 of the back plate 6420 may have a decorative design thereon, since the back 6460 may be displayed to others when the user is viewing his/her portable electronic device.

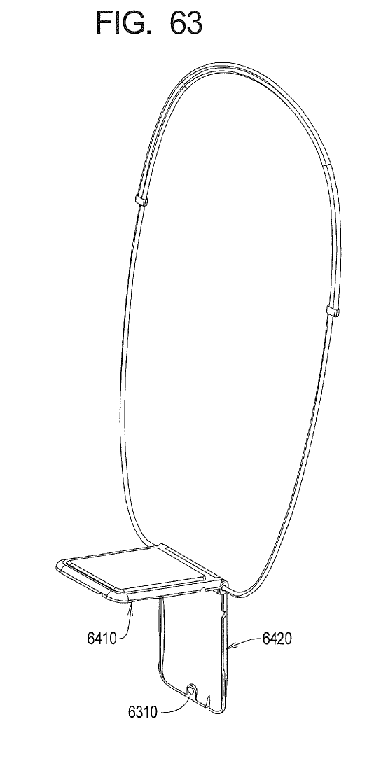

As shown in FIG. 63, the front plate 6410 and the back plate 6420 are pivotable relative to one another via a hinge. In one embodiment, the front plate 6410 and the back plate 6420 may be maintained in a closed position (as shown in FIG. 61) through use of one or more magnets 6310, wherein an exemplary magnet 6310 is shown in FIG. 63.

In one embodiment, when the front plate 6410 and the back plate 6420 are in a closed position, they include a cavity therebetween. In one embodiment, the cavity is used as part of a cable management system.

More specifically, with reference to FIG. 64, headphone jack ports 6470A, 6470B are formed in the front plate 6410 and the back plate 6420, and cooperate to receive the body of a headphone jack (not shown), with the metallic connector portion of the headphone jack being received by the portable electronic device. In one embodiment, left-ear and right-ear headphone cables are placed within the cavity and exit through left-ear cable port 6472A, 6472B and right-ear cable port 6474A, 6474B (not shown in FIG. 64), respectively, formed in the front plate 6410 and the back plate 6420.

In one embodiment, cable ports 6472A, 6472B and 6474A, 6474B are smaller than the headphone jack ports 6470A, 6470B. In one embodiment, the cavity acts as a storage compartment (e.g., for credit cards, bills, change, etc.).

In one embodiment, no internal compartment is provided. Accordingly, in such embodiment, the back plate 6420 and the hinge are not included. In one embodiment, the back of the front plate 6410 includes a decorative design thereon.

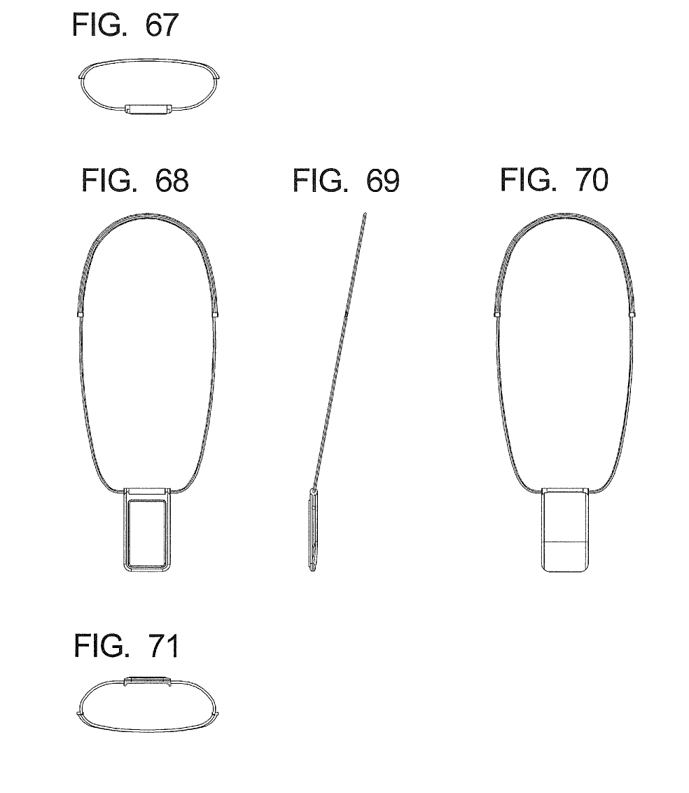

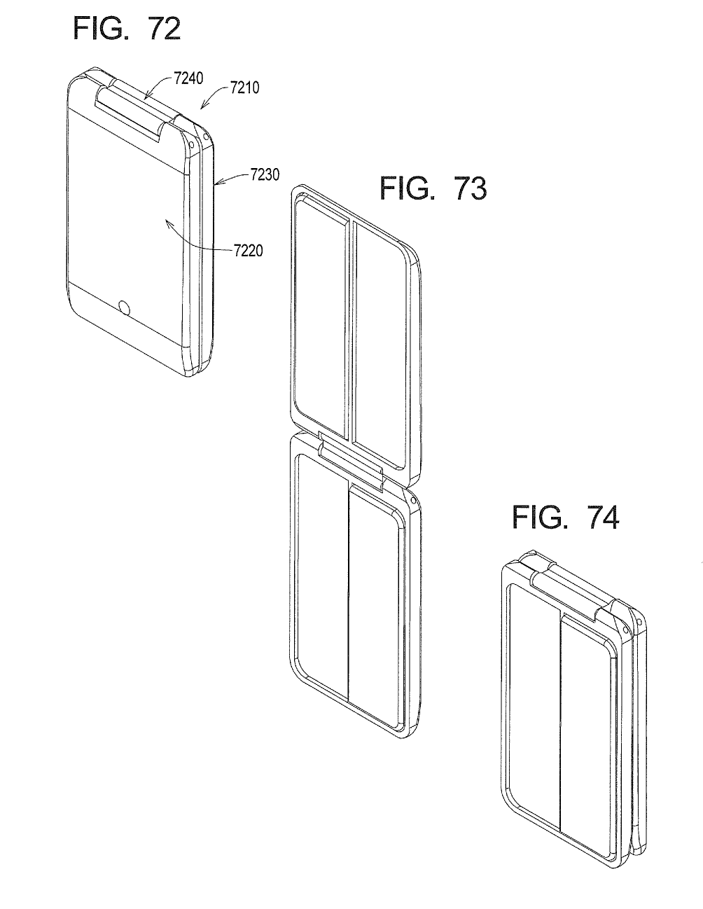

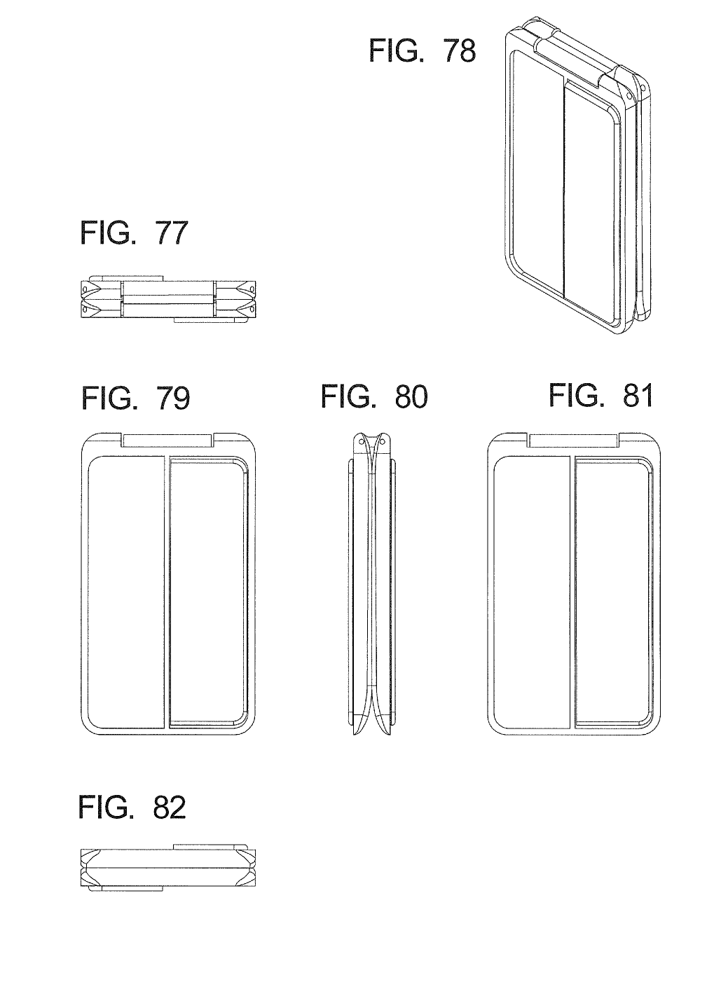

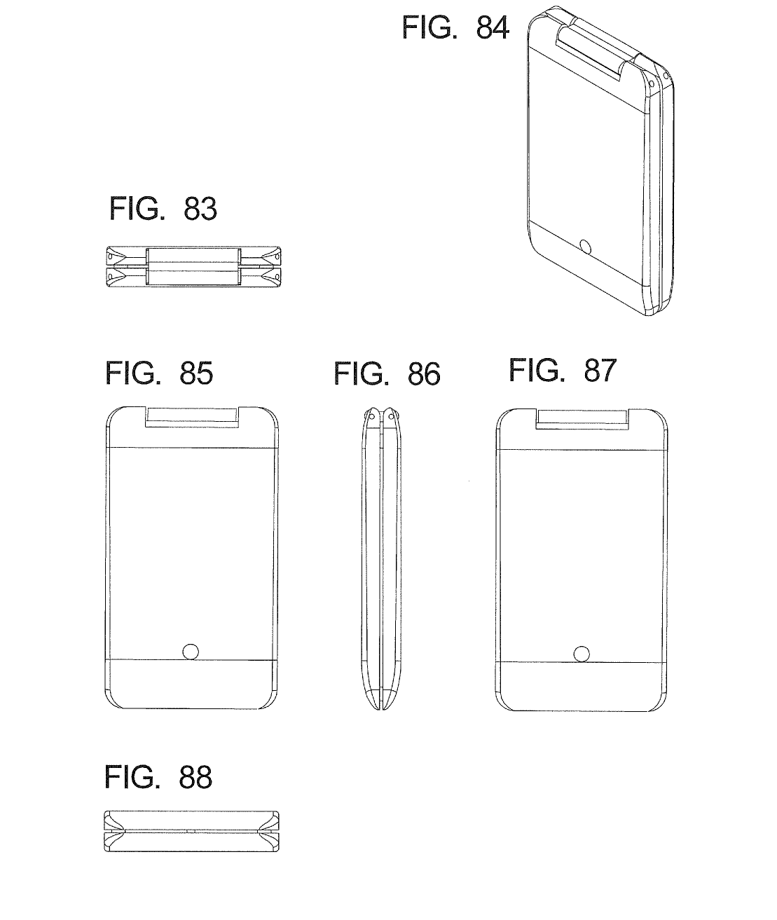

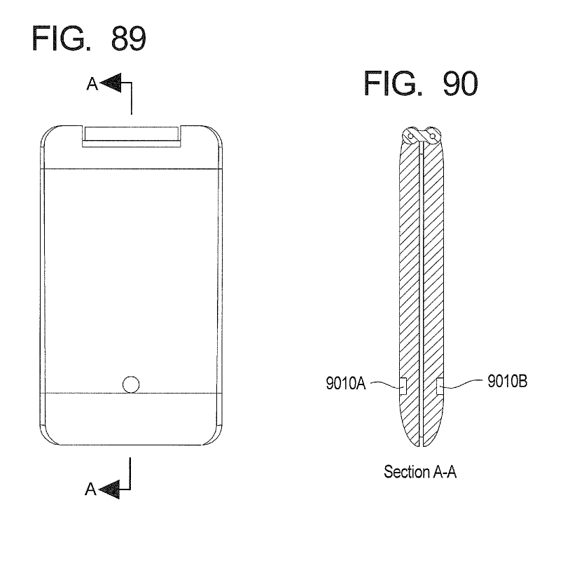

FIGS. 72-90 illustrate various views of a stand 7210 that may be used, for example, when tethering a portable electronic device to a computer. Certain portable electronic devices (e.g., mobile telephones) may be used to provide wireless Internet access for a computer. This process is known as tethering.

As shown in FIG. 72, the stand 7210 includes a first display platform 7220 and a second display platform 7230, which are connected via a hinge system 7240. In one embodiment, the hinge system 7240 is a double-hinge system.

FIGS. 72 and 83-90 show various views of the stand 7210 in a closed (non-deployed) configuration. FIG. 73 shows the stand 7210 in a semi-deployed configuration. FIGS. 74 and 77-82 show various views of the stand 7210 in a fully-deployed configuration.

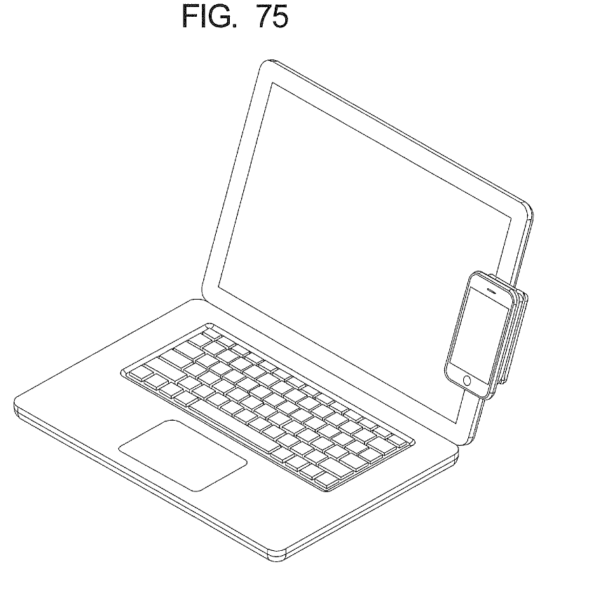

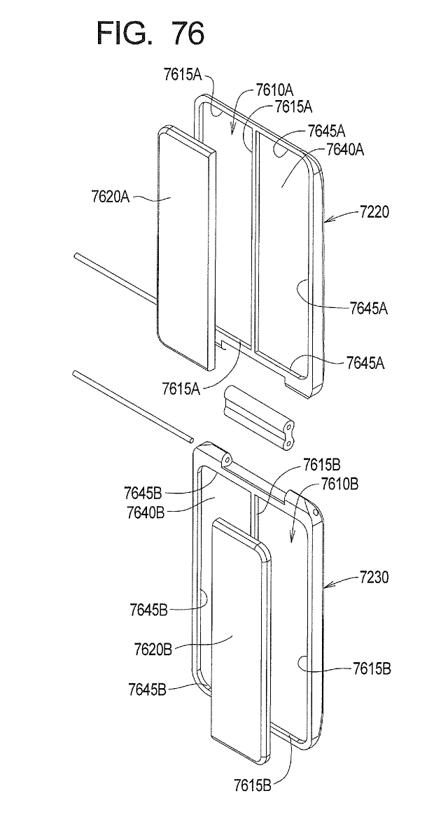

As shown in FIG. 76, the first display platform 7220 includes a first face 7610A with a first border 7615A. A first gripping pad 7620A attaches to the first face 7610A of the first display platform 7220 and its edges lie within the first border 7615A.

Similarly, the second display platform 7230 includes a first face 7610B with a first border 7615B. A second gripping pad 7620B attaches to the first face 7610B of the second display platform 7230 and its edges lie within the first border 7615B.

The first face 7610A of the first display platform 7220 includes an area 7640A with a second border 7645A. Similarly, the first face 7610B of the second display platform 7230 includes an area 7640B with a second border 7645B. When the stand 7210 is in a closed configuration, the first gripping pad 7620A is received within the area 7640B defined by second border 7645B and the second gripping pad 7620B is received within the area 7640A defined by second border 7645A.

As shown in FIG. 75, when the stand 7210 is fully-deployed, the first gripping pad 7620A may be attached to a surface such as a computer screen or computer housing. In such case, the second gripping pad 7620B may be used to suspend a portable electronic device.

With reference to FIG. 90, one or more magnets 9010A, 9010B may be provided. When the stand 7210 is fully-deployed, the one or more magnets 9010A, 9010B assist in holding the stand 7210 in such position. Conversely, when the stand 7210 is in a non-deployed position, the first and second gripping pads 7620A, 7620B assist in maintaining the stand 7210 such position by sticking to the surfaces respectively adjacent thereto. In one embodiment, no magnets are provided.

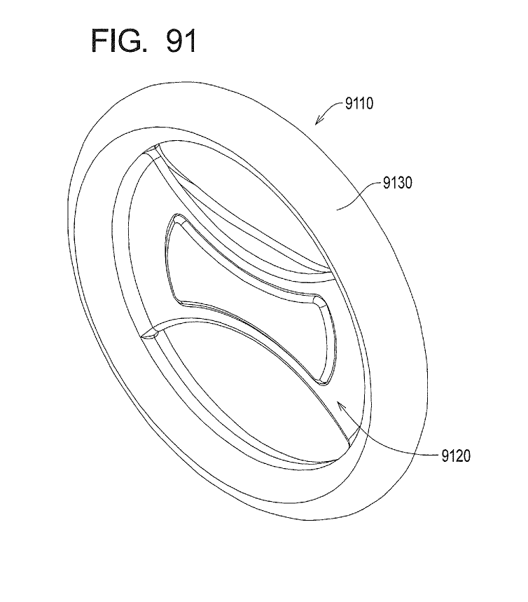

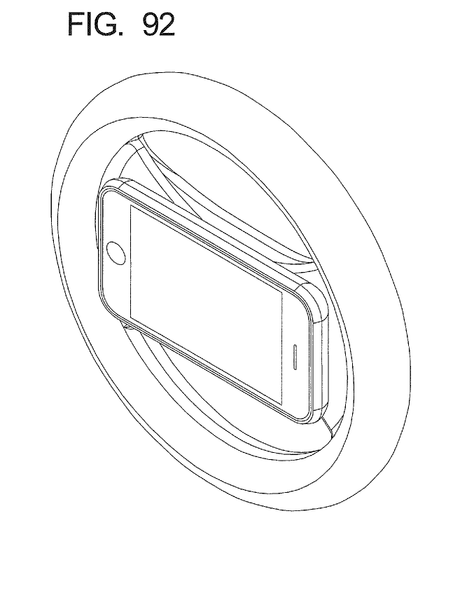

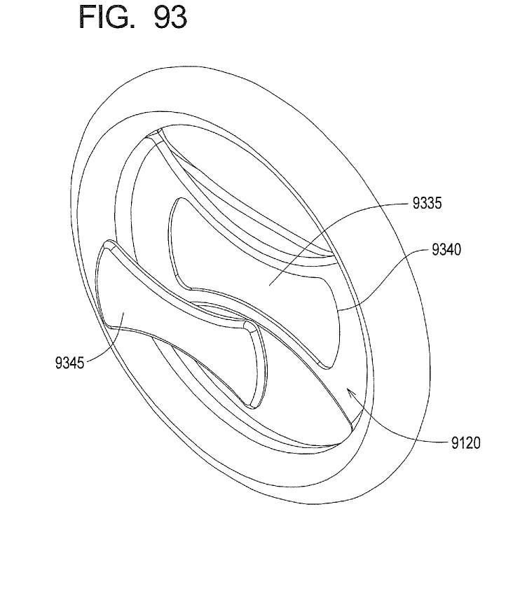

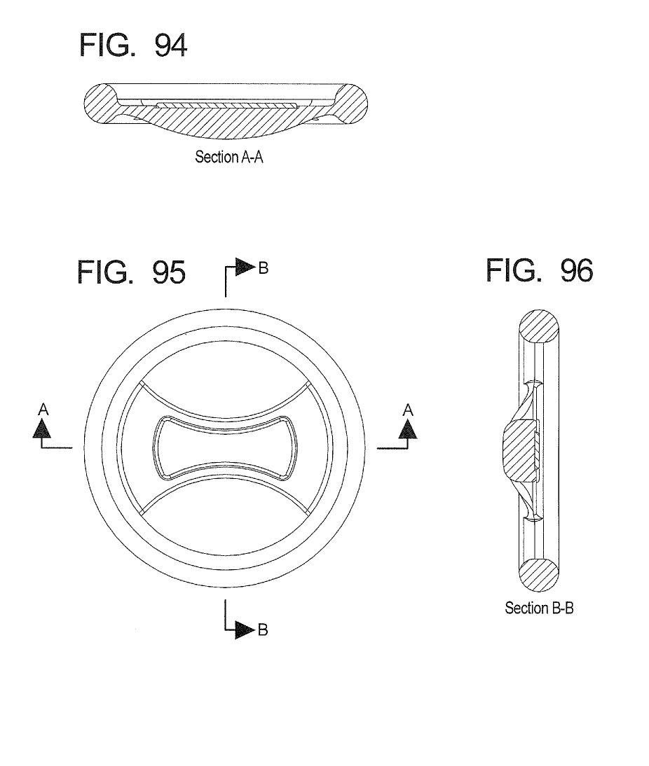

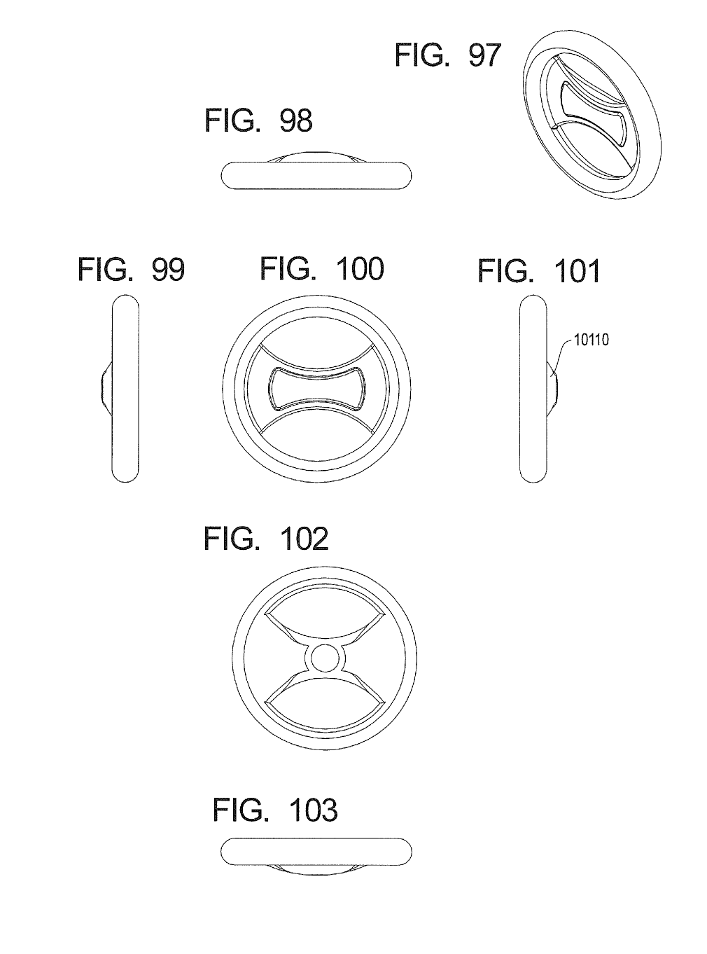

FIGS. 91-103 illustrate various views of a game wheel stand 9110, which itself is a display platform for a portable electronic device. The game wheel stand 9110 includes a platform body 9120 and a steering wheel 9130.

The platform body 9120 includes a face 9335 with a border 9340. A gripping pad 9345 attaches to the face 9355 and its edges lie within the border 9340. As shown in FIG. 92, the gripping pad 9345 may be used to suspend a portable electronic device.

The game wheel stand 9110 may be used in combination with a portable electronic device to play, for example, driving games. It should be understood that other games may also be played using the game wheel stand 9110.

As shown FIG. 101, in one embodiment, the game wheel stand 9110 includes a generally convex bottom 10110, which may be used to spin the game wheel stand 9110 like a top. The generally convex bottom 10110 provides additional gaming versatility, among other things.

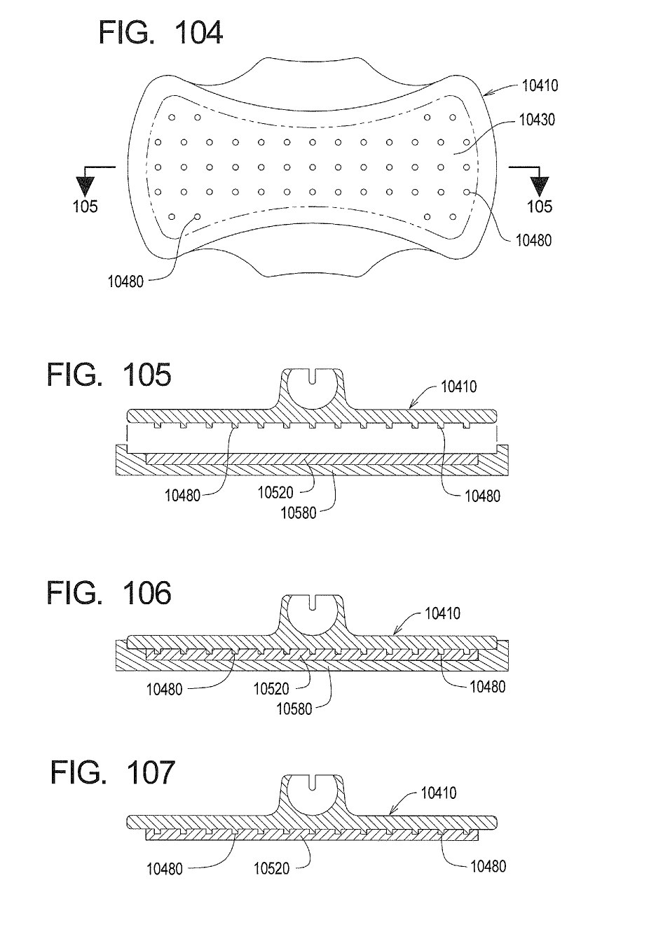

FIG. 104 is a front view of a platform body 10410 similar to the platform body 1510 shown in FIG. 15. Platform body 10410 has a face 10430 with one or more protrusions 10480, which increase the surface area of the face 10430 as opposed to a platform body with a smooth face.

In one embodiment, a gripping pad (similar to gripping pad 1520) has a surface (e.g., a back) with recesses (not shown) which correspond with the protrusions 10480 on the face 10430 of the platform body 10410. The increased surface area between the protrusions 10480 on the face 10430 of the platform body 10410 and the recesses in the gripping pad may increase the grip between the gripping pad and the platform body 10410.

In one embodiment, the protrusions 10480 are used to attach the platform body 10410 to a gripping pad prior to the gripping pad being finally formed or cured. This embodiment is illustrated via FIGS. 105-107.

FIG. 105 is a cross-sectional view along lines 105-105 of FIG. 104 of the platform body 10410 just prior to it being placed into contact with a molten gripping pad material 10520 that is held in a mold 10580. As part of the manufacturing process, the mold 10580 was created and molten material that forms the gripping pad 10520 was poured into the mold 10580.

FIG. 106 is a view similar to FIG. 105, except that the platform body 10410 has been place into contact with the molten gripping pad material 10520 that is being held by the mold 10580. FIG. 107 is a view similar to FIG. 106, except that the gripping pad material 10520 is attached to the platform body 10410, has cured and has been removed from the mold 10580.

It should be understood that techniques other than or in addition to pour molding may be used to form the gripping pad. For example, injection molding and/or overmolding techniques may be used. Furthermore, in one embodiment, the gripping pad material may be sprayed onto the platform body or other surface.

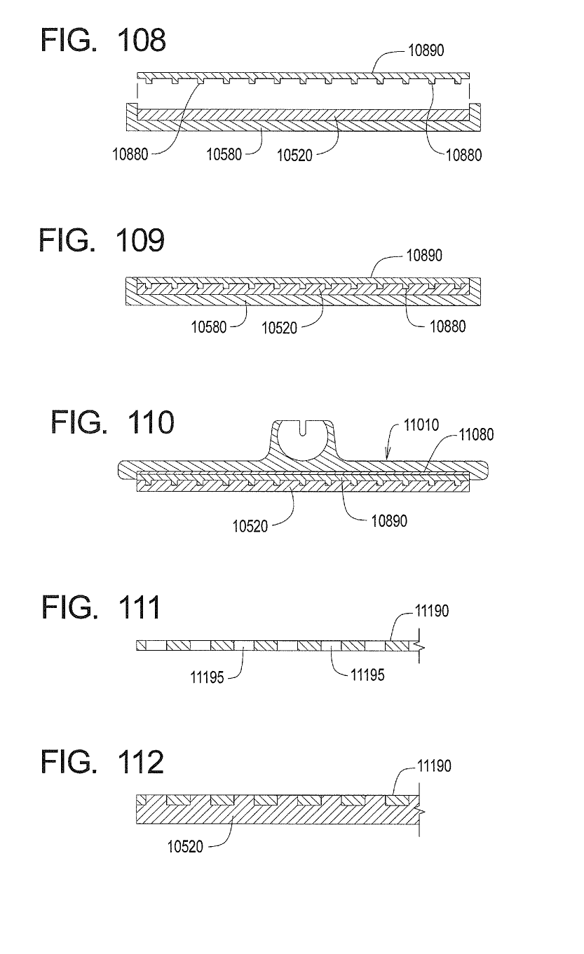

In some embodiments, instead of the gripping pad being attached directly to the platform body, an intermediate plate may be used, as described in connection with FIGS. 108-116. The intermediate plate may be made of a variety of materials including, for example, plastic, metal or rubber.

FIG. 108 is a cross-sectional view of a first embodiment of an intermediate plate 10890 just prior to it being placed into contact with molten gripping pad material 10520 that is held in a mold 10580. Like platform body 10410, intermediate plate 10890 has one or more protrusions 10880. FIG. 109 is a view similar to FIG. 108, except that the intermediate plate 10890 has been placed into contact with the molten gripping pad material 10520 that is being held by the mold 10580.

After the gripping pad material 10520 has cured, it is removed from the mold 10580 and is attached to the intermediate plate 10890. FIG. 110 is a sectional view showing an intermediate plate 10890 that is attached to a gripping pad 10520 using the technique described in connection with FIGS. 108 and 109. FIG. 110 also shows that the intermediate plate 10890 is attached to a platform body 11010 with an adhesive 11080.

In one embodiment, the intermediate plate 10890 is attached to a platform body 11010 with “snap-fit” type features. For example, tabs and corresponding detents (or other features) could be used to allow the intermediate plate 10890 and platform body 11010 to mate, with or without an adhesive.

FIG. 111 is a cross-sectional view of a second embodiment of an intermediate plate 11190, which includes one or more holes 11195 that can be a variety of shapes (e.g., when viewed from above the holes 11195 may be circular, polygonal, etc.). FIG. 112 is a cross-sectional view of the second embodiment of the intermediate plate 11190 after the gripping pad material 10520 has cured and is attached to the intermediate plate 11190.

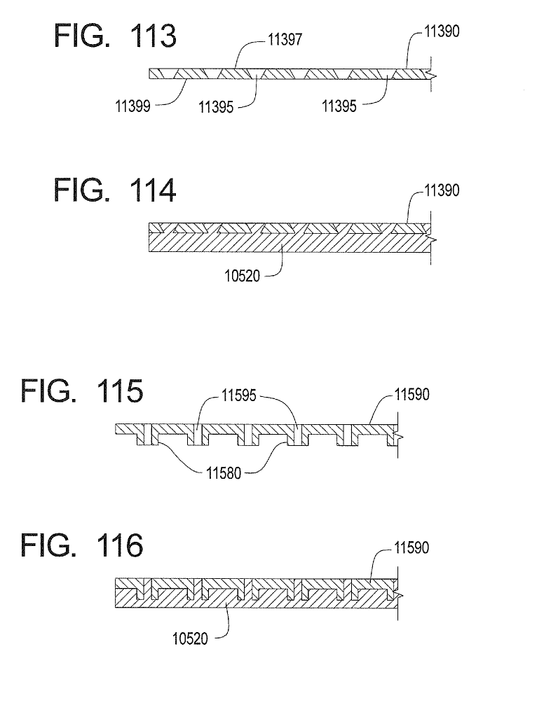

FIG. 113 is a cross-sectional view of a third embodiment of an intermediate plate 11390, which includes one or more holes 11395. The intermediate plate 11390 has a first face 11397 and a second face 11399. The holes 11395 have a larger diameter when viewed from the first face 11397 and a smaller diameter when viewed from the second face 11399. FIG. 114 is a cross-sectional view of the third embodiment of the intermediate plate 11390 after the gripping pad material 10520 has cured and is attached to the intermediate plate 11390.

FIG. 115 is a cross-sectional view of a fourth embodiment of an intermediate plate 11590, which includes one or more protrusions 11580 that have one or more holes 11595 therein. FIG. 116 is a cross-sectional view of the fourth embodiment of the intermediate plate 11590 after the gripping pad material 10520 has cured and is attached to the intermediate plate 11590.

While the embodiments shown in FIGS. 104-116 provide examples of items that are placed into contact with gripping pad material that has already been poured into a mold, it should be understood that the gripping pad material may be poured into an item (e.g., an intermediate plate or platform body). Furthermore, the item might have channels therein into which molten gripping pad material may flow to create a mechanical link between the item and the gripping pad.

In one embodiment, no channels, holes, protrusions or other features are included in the item. In one embodiment, the PU gel (or other material) creates a chemical bond with the item (e.g., platform body or intermediate plate) during curing, regardless of whether the item is smooth or has channels, holes, protrusions or other features.

In some instances, it is advantageous to provide another technique for attaching a gripping pad to an item. For example, with certain types of porous materials (like fabric or leather), the gripping pad may not stick particularly well thereto. However, if a technique was provided for the gripping pad to be attached to such items, the exposed surface of the gripping pad may still be able to secure portable electronic devices or other objects.

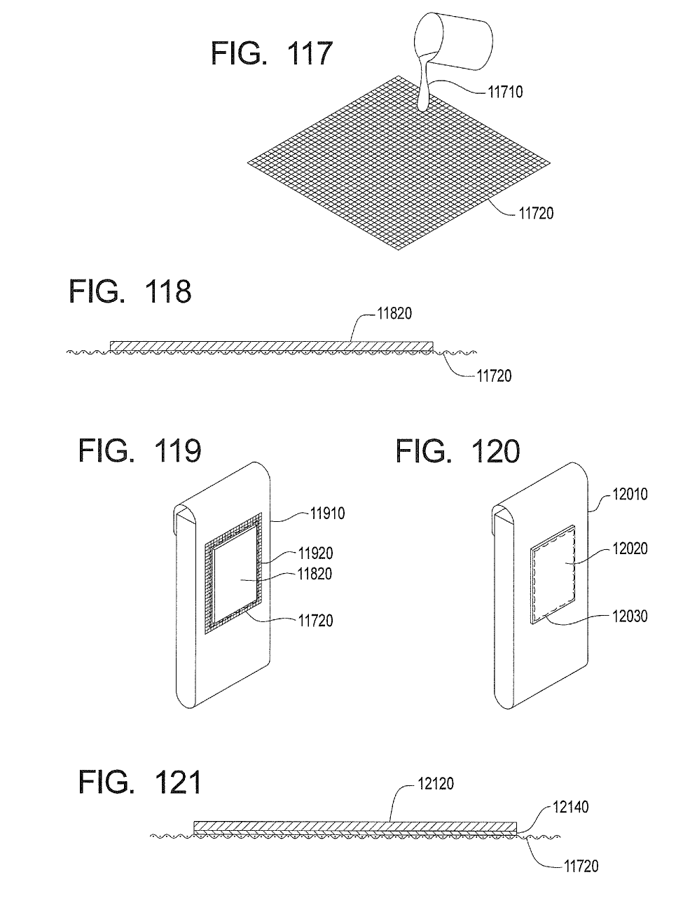

FIG. 117 is a perspective view of gripping pad material in liquid form 11710 being poured onto a piece of mesh material 11720. In one embodiment, the piece of mesh material 11720 is suspended above or suspended within a mold (not shown), so that the gripping pad material becomes bonded to or becomes integral with the mesh 11720, once the gripping pad material has cured. One example of a gripping pad 11820 that has become attached to the mesh 11720 is shown in FIG. 118.

As shown in FIG. 119, the edges of the mesh 11720 may then be sewn onto an item 11910 (e.g., a case or bag made of fabric or leather) using, for example, one of several types thread 11920. In addition, an adhesive (not shown) may be applied between the item 11910 and the gripping pad 11820.

FIG. 120 is an isometric view of a gripping pad 12020 that has been sewn to an item 12010 using, for example, one of several types of thread 12030. In the embodiment shown in FIG. 120, no mesh material is provided.

FIG. 121 is a cross-sectional view of a gripping pad 12120 that has been attached to a piece of mesh material 11720 using an adhesive 12140. Then, the mesh material 11720 may be sewn or otherwise attached to an item.

In addition to the techniques described above, it should be understood that other techniques for creating bonds or attaching items together may be used. For example, in addition to the application of adhesives or sewing, ultrasonic welding may be used.

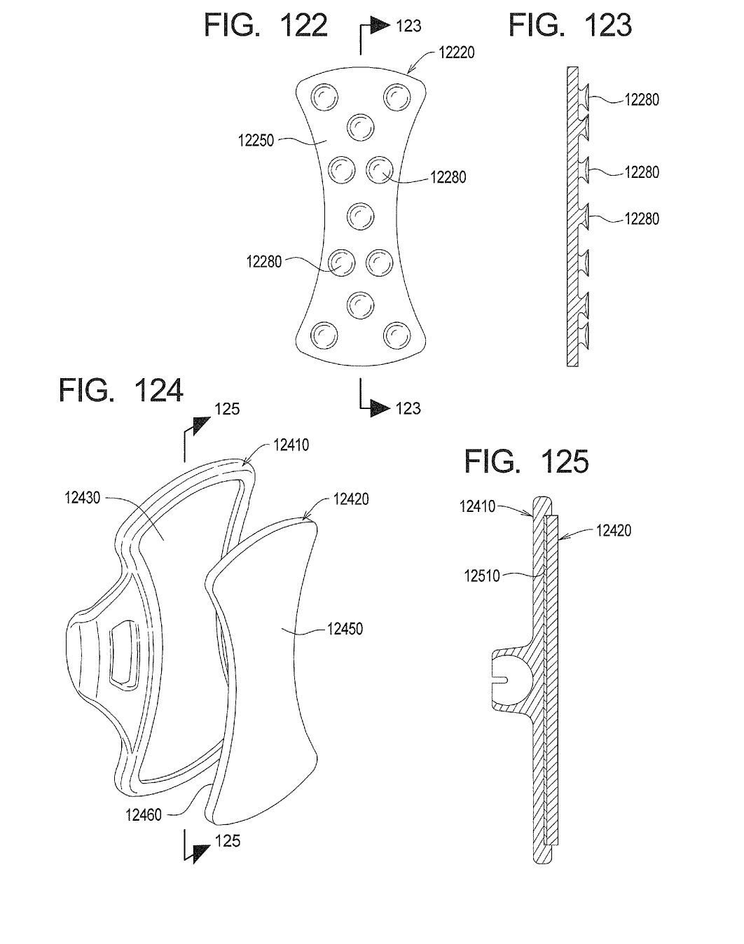

FIG. 122 is a front view of a gripping pad 12220 with suction cups 12280. FIG. 123 is a side view of the gripping pad 12220 taken along line 123-123 of FIG. 122. The gripping pad 12220 may be made of materials already described herein. As an alternative, the gripping pad 12220 may be made of commonly known suction cup materials. In one embodiment, the gripping pad 12220 may be attached to a platform body (not shown in FIGS. 122 and 123) using an adhesive.

FIG. 124 is a view similar to FIG. 15 showing a platform body 12410 and a gripping pad 12420, which attaches to the face 12430 of the platform body 12410. However, the front 12450 of the gripping pad 12420 and the back 12460 of the gripping pad 12420 are smooth and continuous. As shown in FIG. 125, which is a sectional view taken along line 125-125 of FIG. 124, the gripping pad 12420 is attached to the platform body 12410 using an adhesive 12510.

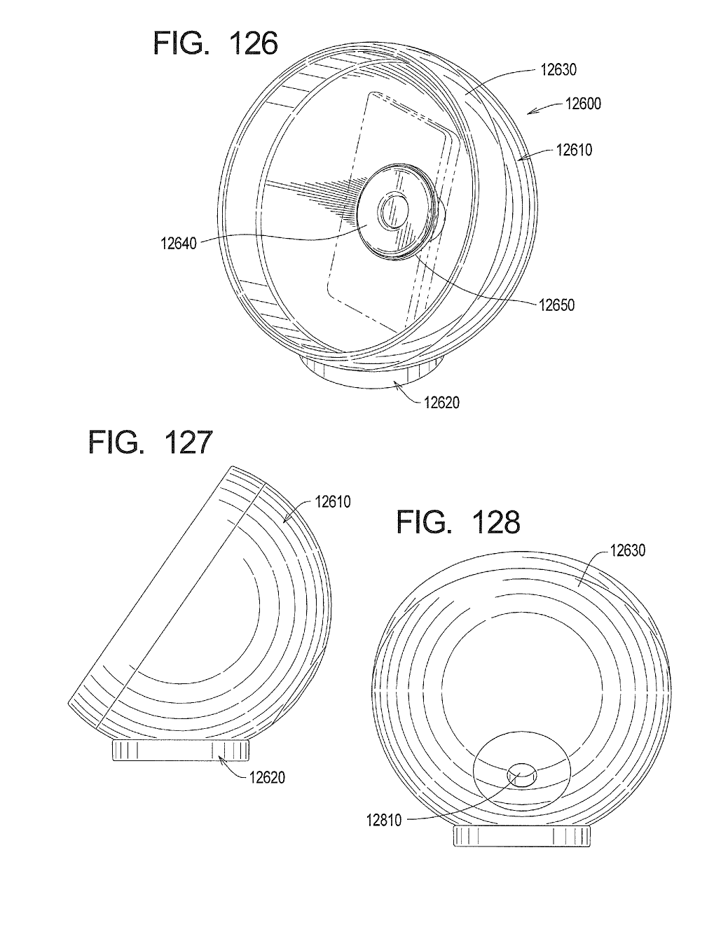

FIGS. 126-128 illustrate various views of a second embodiment of a semi-spherical stand 12600. The semi-spherical stand 12600 includes a display platform 12610 and a base 12620.

A gripping pad 12640 attaches to a platform body 12650. As shown in FIG. 126, the gripping pad 12640 may be used to suspend a portable electronic device (shown in phantom). The display angle of the portable electronic device may be modified by changing the position of the display platform 12610 relative to the base 12620.

In one embodiment, the gripping pad 12640 may take the shape of a ring, so as to allow a cable to pass through its center. As shown in FIG. 128, the housing 12630 of the display platform 12610 includes an aperture 12810, which corresponds with the position of the gripping pad 12640. The aperture 12810 permits passage of a cable (not shown) therethrough. The cable may be attached to a portable electronic device that is suspended by the gripping pad 12640, so as to charge the portable electronic device.

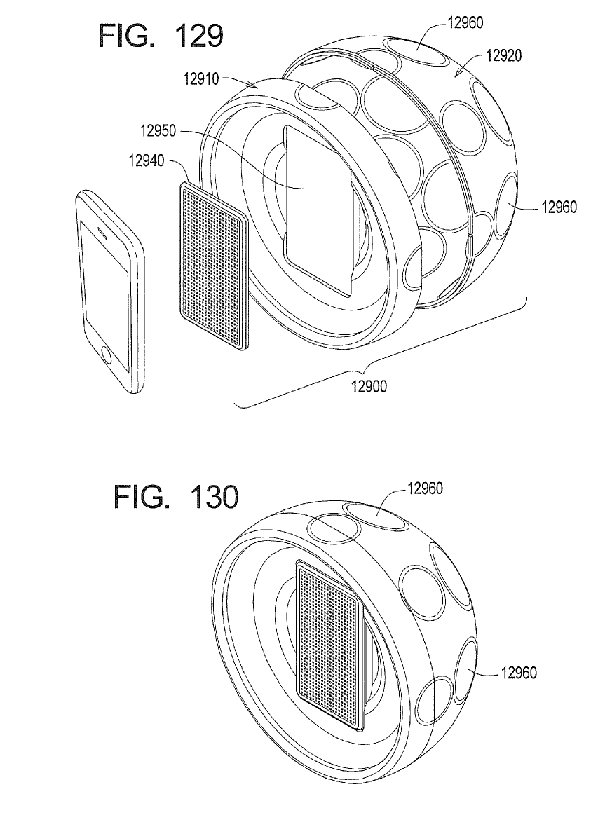

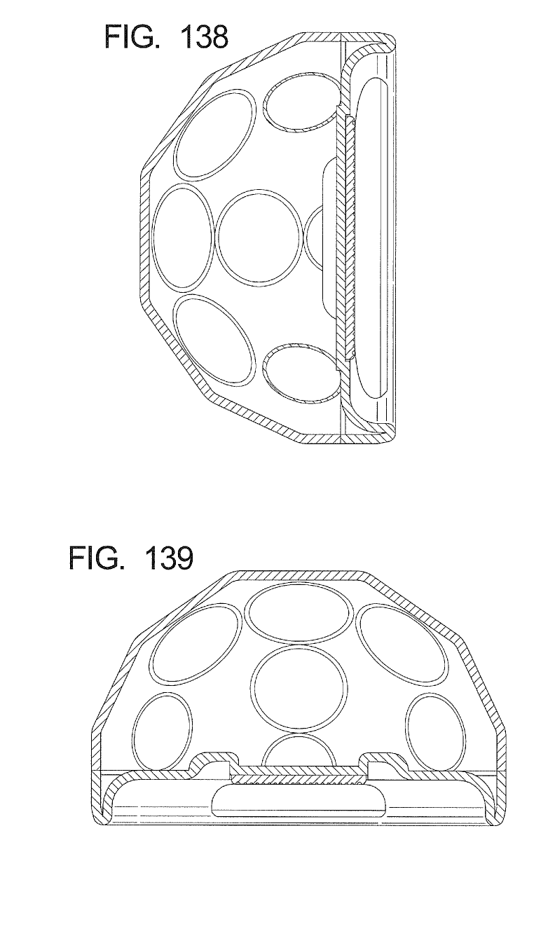

FIGS. 129-139 illustrate various views of a third embodiment of a semi-spherical stand 12900, along with a portable electronic device. The semi-spherical stand 12900 includes a display platform 12910 and a base 12920.

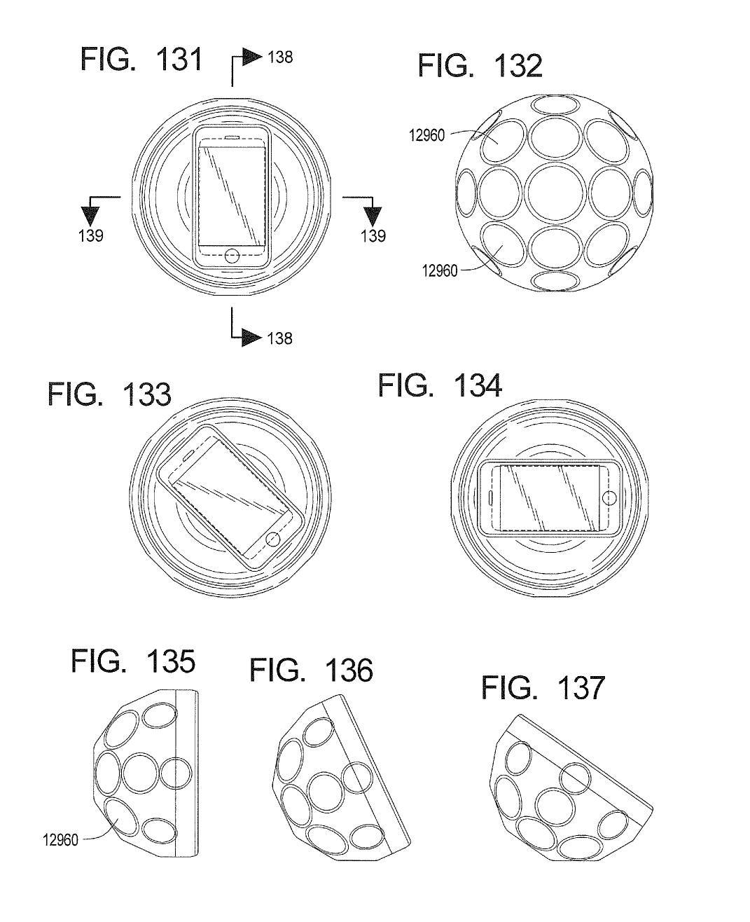

A gripping pad 12940 attaches to a platform body 12950. The gripping pad 12940 may be used to suspend a portable electronic device (see FIGS. 131, 133 and 134).

The display platform 12910 and the base 12920 may be attached to one another gluing, ultrasonic welding or other well-known techniques. Alternatively, the display platform 12910 and the base 12920 may be formed of a single piece.

The base 12920 includes a plurality of facets and/or dimples 12960. As shown in FIGS. 131 and 133-137, the display angle of the portable electronic device may be modified by changing the position of the base 12960 and allowing the stand 12900 to come to rest in a position associated with one or more of the facets and/or dimples 19260.

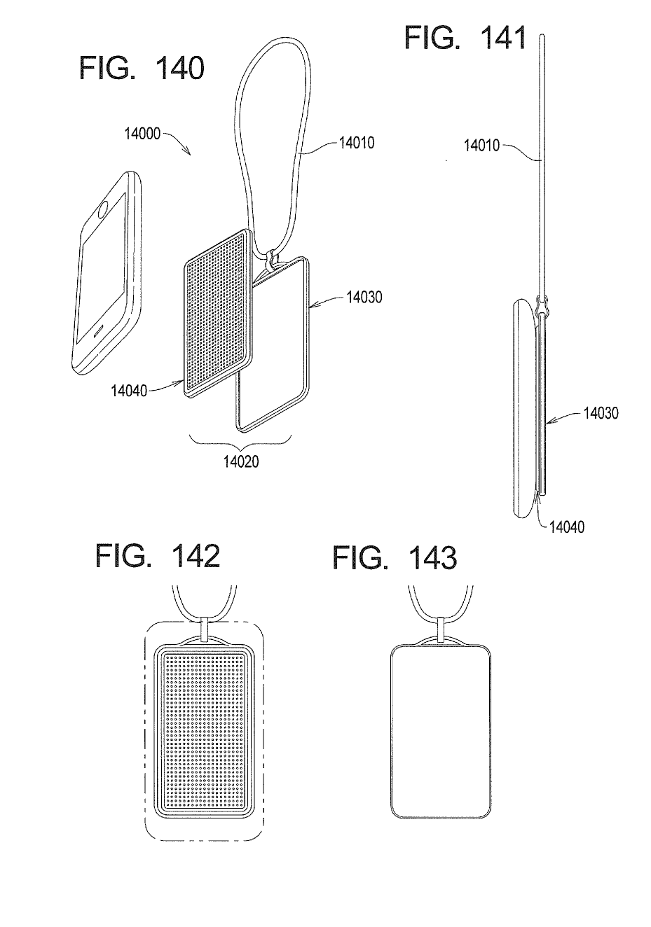

FIGS. 140-143 illustrate various views of a second embodiment of a lanyard-based stand 14000. The lanyard-based stand 14000 includes a neckstrap 14010 and a display platform 14020 (including a platform body 14030 and a gripping pad 14040) that is attached thereto. The gripping pad 14040 is used to suspend a portable electronic device (shown in FIG. 141 and shown in phantom in FIG. 142).

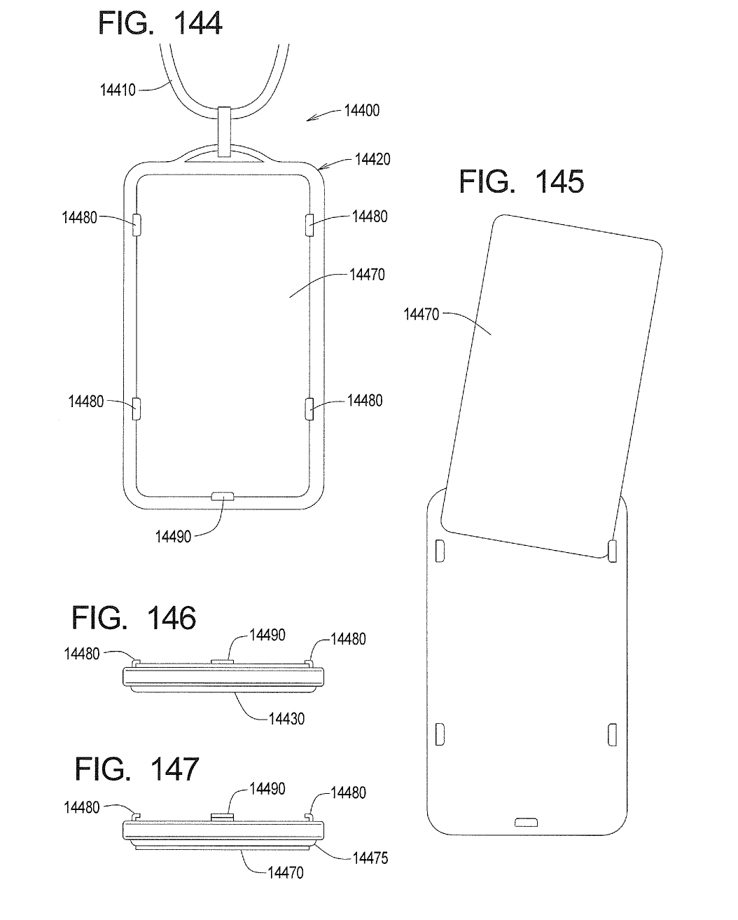

FIGS. 144-147 illustrate various views of a third embodiment of a lanyard-based stand 14400. The stand 14400 includes a neckstrap 14410 (only partially shown) and a display platform 14420 that is attached thereto.

The display platform 14420 has a protective cover 14470 which may be removable attached thereto. The protective cover 14470 is attached to the gripping pad 14475, when the stand 14400 is not in use, so as to protect the gripping pad 14475 from getting dirty (see FIG. 147).

However, when the stand 14400 is to be placed in use, the protective cover 14470 is removed from the gripping pad 14475 and is slid between fingers 14480. The protective cover 14470 comes to rest at stop 14490, which also serves to support the protective cover 14470.

In one embodiment, the protective cover 14470 is fairly rigid like a business card or credit card, so that it may be slid between fingers 14480 with relative ease.

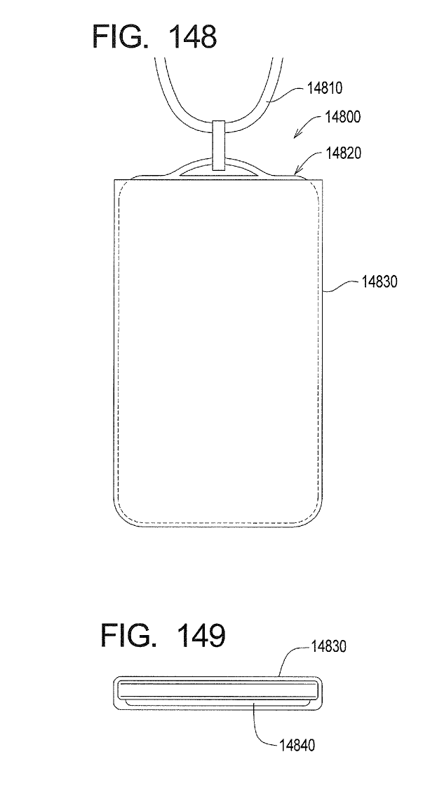

FIGS. 148-149 illustrate various views of a fourth embodiment of a lanyard-based stand 14800. The stand 14800 includes a neckstrap 14810 (only partially shown) and a display platform 14820 that is attached thereto.

When the stand 14800 is not in use, a protective case 14830 is provided, which covers the gripping pad 14840, so as to protect the gripping pad 14840 from getting dirty (see FIG. 147). In one embodiment, the protective case 14830 is made of a material to which the gripping pad 14840 does not easily stick.

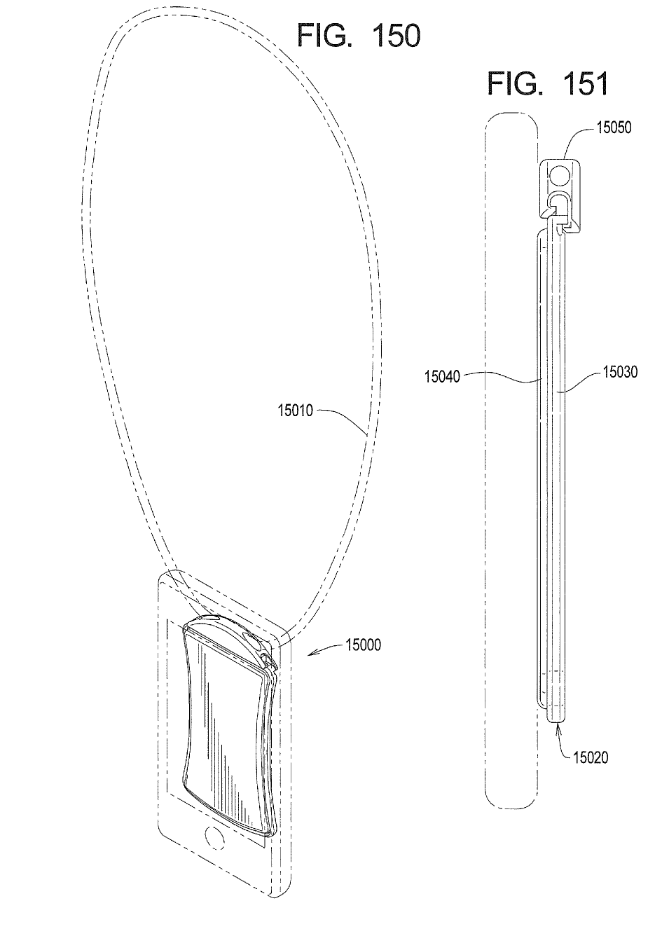

FIGS. 150-151 illustrate various views of a fifth embodiment of a lanyard-based stand 15000. The stand 15000 includes a neckstrap 15010 (shown in phantom) and a display platform 15020 that is attached thereto.

The display platform 15020 includes a platform body 15030, to which a gripping pad 15040 is attached, and a lanyard connector 15050 to provide a mechanism to connect neckstrap 15010. The gripping pad 15040 may be used to suspend a portable electronic device (shown in phantom).

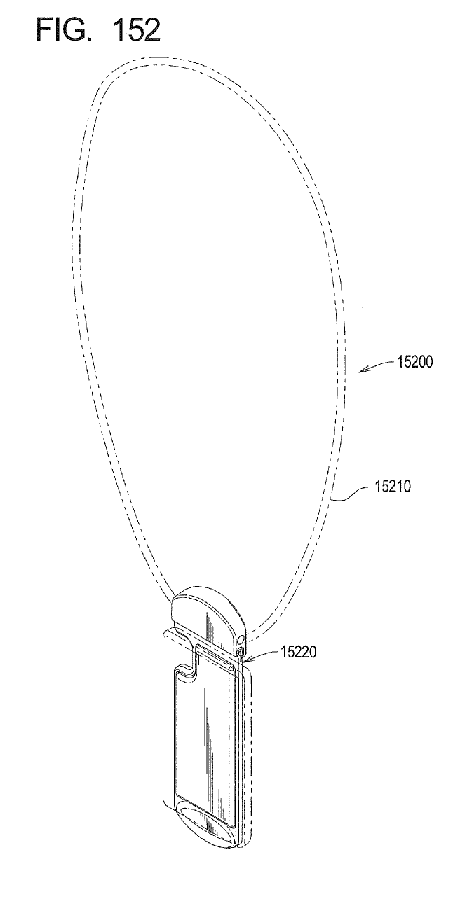

FIGS. 152-154 illustrate various views of a sixth embodiment of a lanyard-based stand 15200. The stand 15200 includes a neckstrap 15210 (shown in phantom) and a display platform 15220 that is attached thereto.

The display platform 15220 includes a platform body 15230, to which a gripping pad 15240 is attached, and a lanyard connector 15250 to provide a mechanism to connect neckstrap 15210. The gripping pad 15240 may be used to suspend a portable electronic device (shown in phantom).

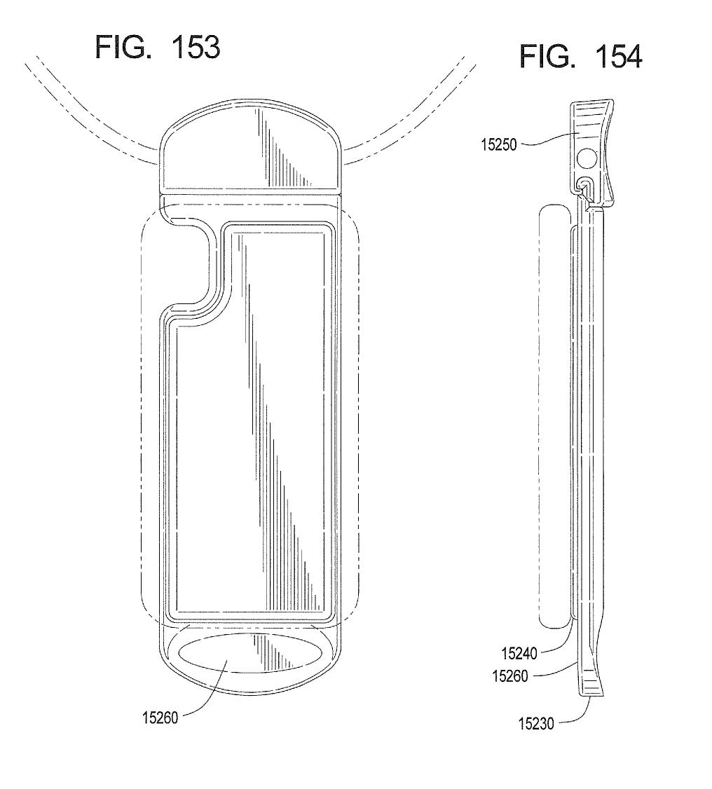

In one embodiment, the stand 15200 is designed to support a portable electronic device that includes a lens (e.g., an iPod® Nano music player/video camera). In such case, the platform body 15230 and the gripping pad 15240 are shaped to accommodate the position of the lens (see FIGS. 152 and 153). Furthermore, the lanyard connector 15250 and the bottom 15260 of the platform body 15230 may be sized such that a user may easily grip same when shooting video or taking photographs.

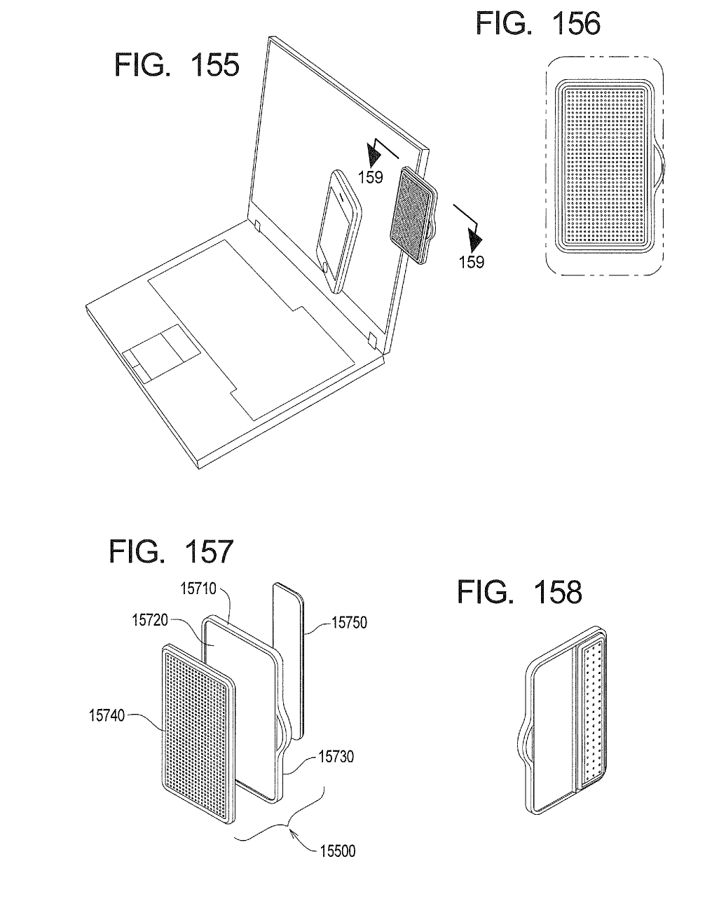

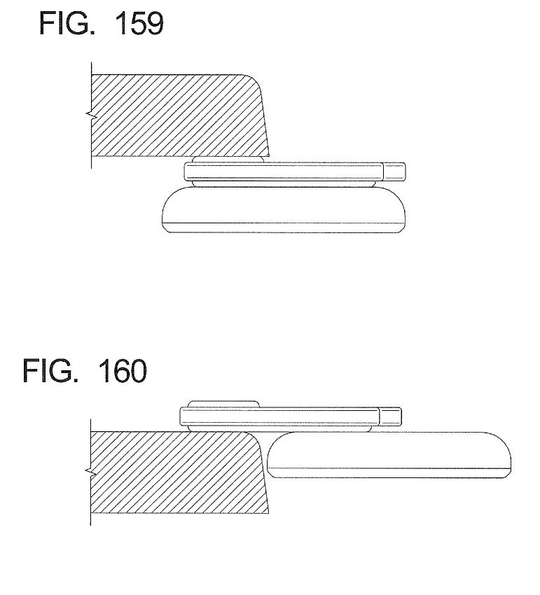

FIGS. 155-160 illustrate various views of a second embodiment of a stand 15500 that may be used when tethering a portable electronic device to a computer or other item. As shown in FIG. 157, the stand 15500 includes a platform body 15710 having a front 15720 and a back 15730. The stand 15500 also includes a first gripping pad 15740 and a second gripping pad 15750.

The first gripping pad 15740 is attached to the front 15720 of the platform body 15710 and is used to suspend a portable electronic device therefrom. The second gripping pad 15750 is, (in one embodiment) smaller than the first gripping pad 15740, and is attached to the back 15730 of the platform body 15710. When in use, the second gripping pad 15750 is also attached to a computer or other item.

In one embodiment, shown in FIG. 160, the first gripping pad 15740 may be used to suspend a portable electronic device and connect to a computer or other item.

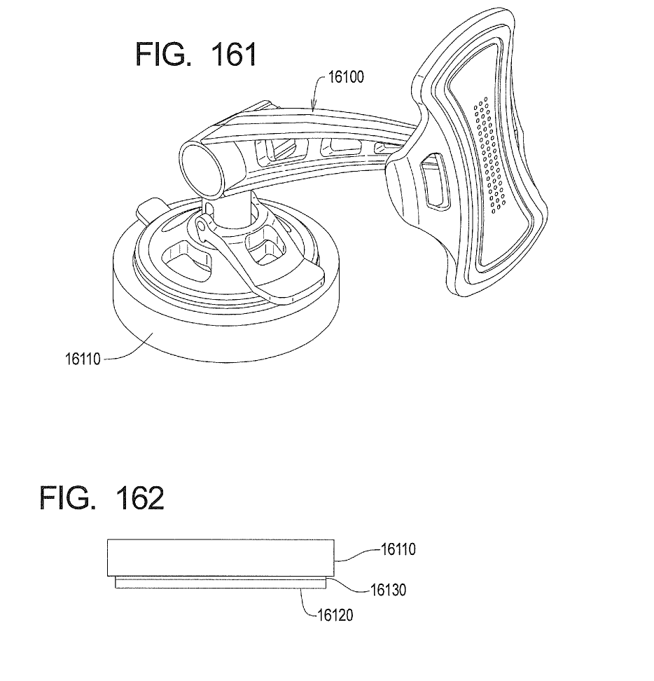

FIG. 161 (which is similar to FIG. 34) illustrates a stand 16100 that has been attached to a disk 16110. As shown in FIG. 162, the disk 16110 has a surface gripping pad 16120 that is attached to the bottom of the disk 16110 using an adhesive 16130.

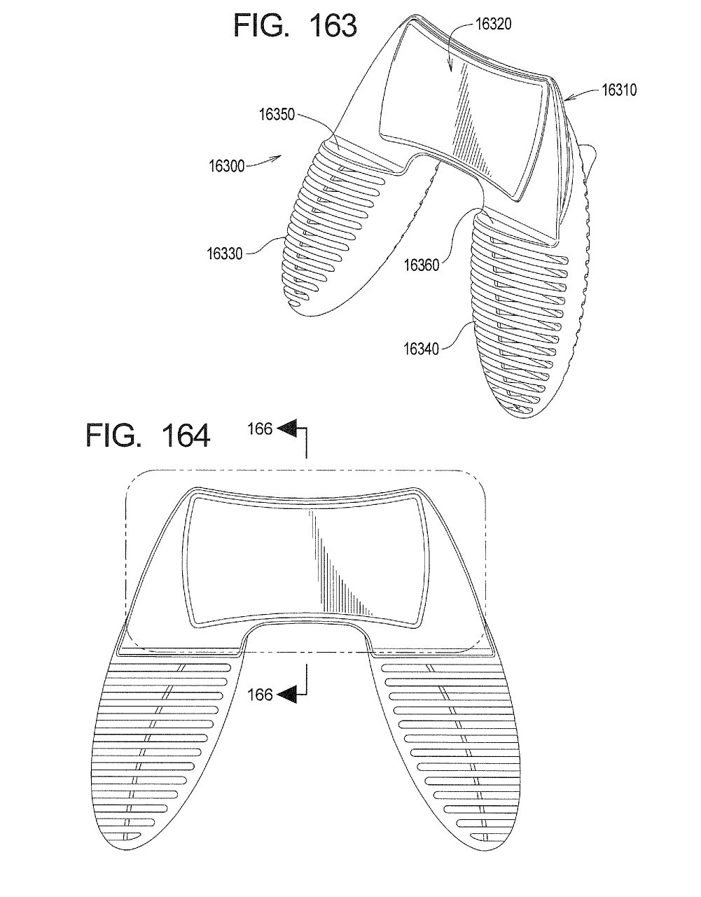

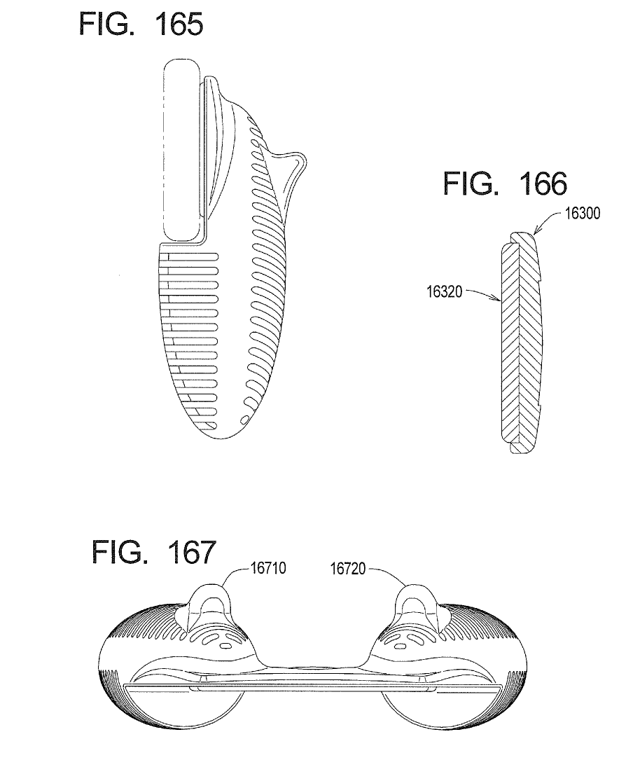

FIGS. 163-167 illustrate various views of an exemplary stand 16300 with a v-shaped handle. The stand 16300 may be useful when the portable electronic device is being used for gaming, among other things.

The stand 16300 includes a platform body 16310 and a gripping pad 16320. The platform body 16310 includes first and second arms 16330 and 16340. The first arm 16330 has a first ledge 16350 and the second arm 16340 has a second ledge 16360. Furthermore, first arm 16330 may include a first finger grip 16710 and second arm 16340 may include a second finger grip 16720.

In one embodiment, the first and second ledges 16350, 16360 are not necessary to support the portable electronic device. Instead, they are used to assist in properly positioning the portable electronic device for game playing access.

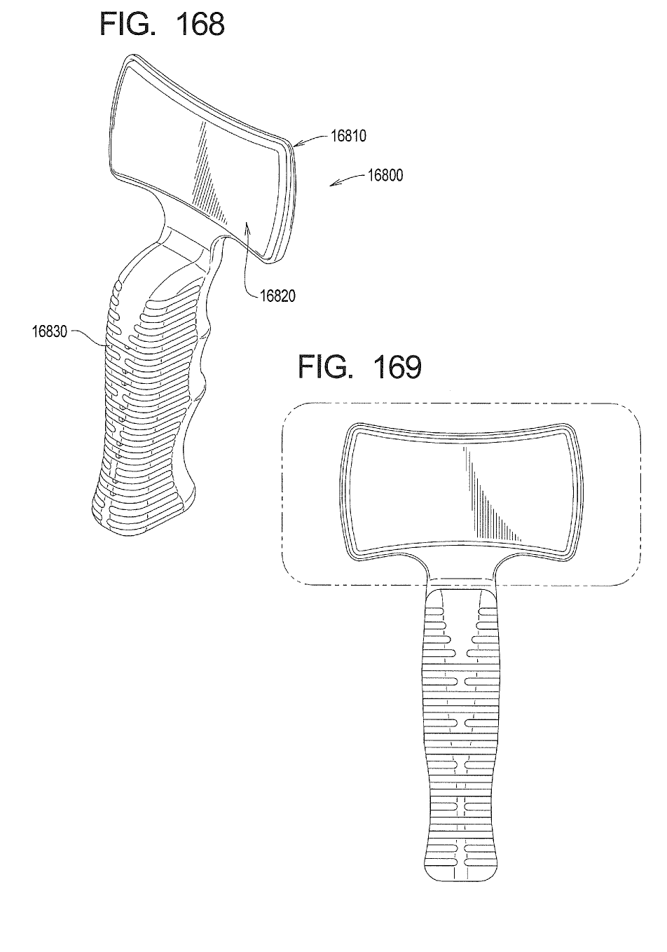

FIGS. 168-170 illustrate various views of an exemplary stand 16800 with a pistol-grip type handle. The stand 16800 may be useful when the portable electronic device is being used for gaming, among other things.

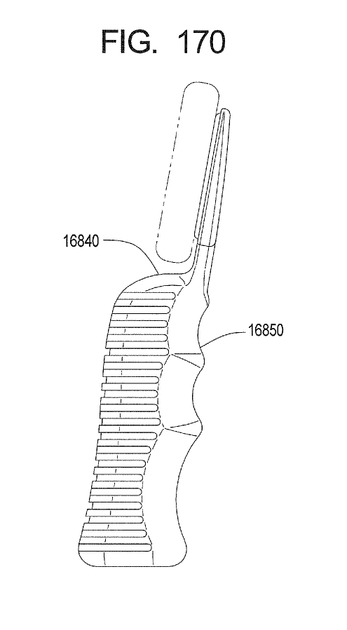

The stand 16800 includes a platform body 16810 and a gripping pad 16820. The stand includes an arm 16830, which has a ledge 16840 and finger grips 16850. In one embodiment, the ledge 16840 is not necessary to support the portable electronic device (see, e.g., FIG. 170). Instead, it is used to assist in properly positioning the portable electronic device for game playing access.

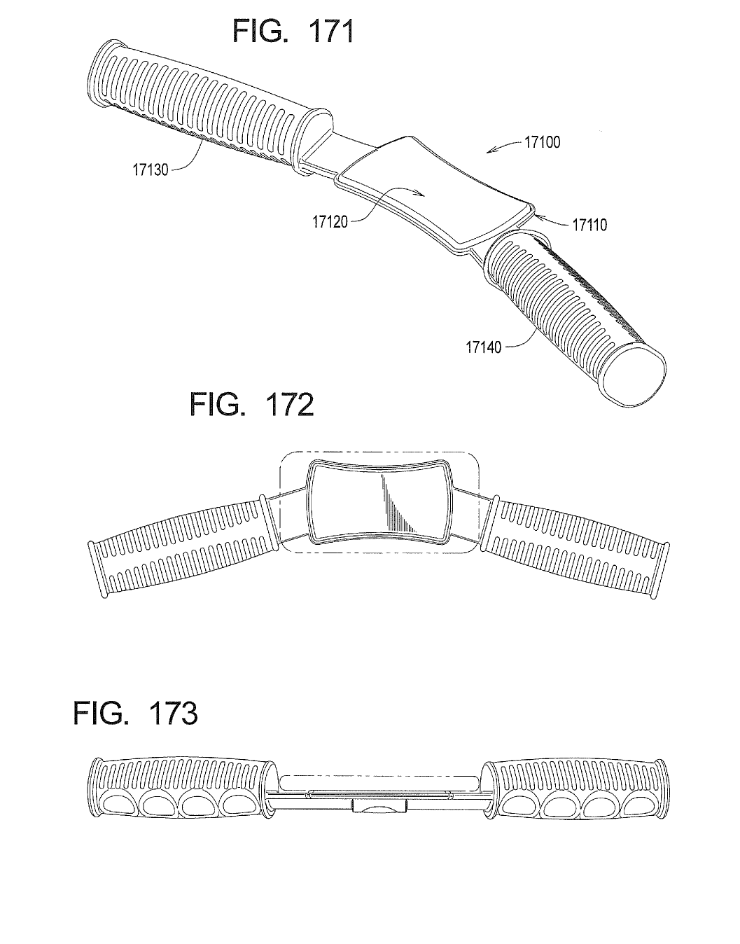

FIGS. 171-173 illustrate various views of an exemplary stand 17100 with a handlebar type handle. The stand 17100 may be useful when the portable electronic device is being used for gaming, among other things.

The stand 17100 includes a platform body 17110 and a gripping pad 17120. The platform body 17110 includes first and second arms 17130 and 17140. The platform body 17110 is designed to assist in properly positioning the portable electronic device for game playing access.

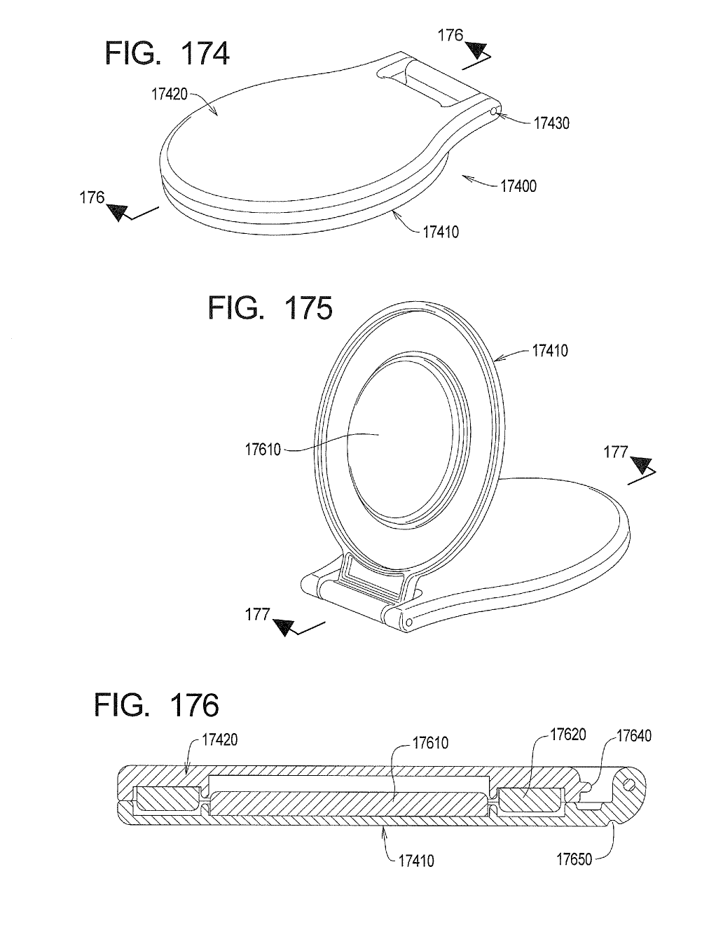

FIGS. 174-178 illustrate various views of a compact-type universal stand 17400. The stand 17400 has a first platform body 17410 and a second platform body 17420, which are pivotally connected to one another (e.g., by a hinge 17430).

As shown in FIG. 176, the first platform body 17410 has a first gripping pad 17610 attached thereto and the second platform body 17420 has a second gripping pad 17620 attached thereto. The first gripping pad 17610 is circular in shape and the second gripping pad 17620 has a ring shape with an inner diameter larger than the outer diameter of the first gripping pad 17610. When the stand 17400 is in a closed configuration, both the first gripping pad 17610 and the second gripping pad 17620 are protected from the environment, so as to reduce the likelihood of them becoming dirty.

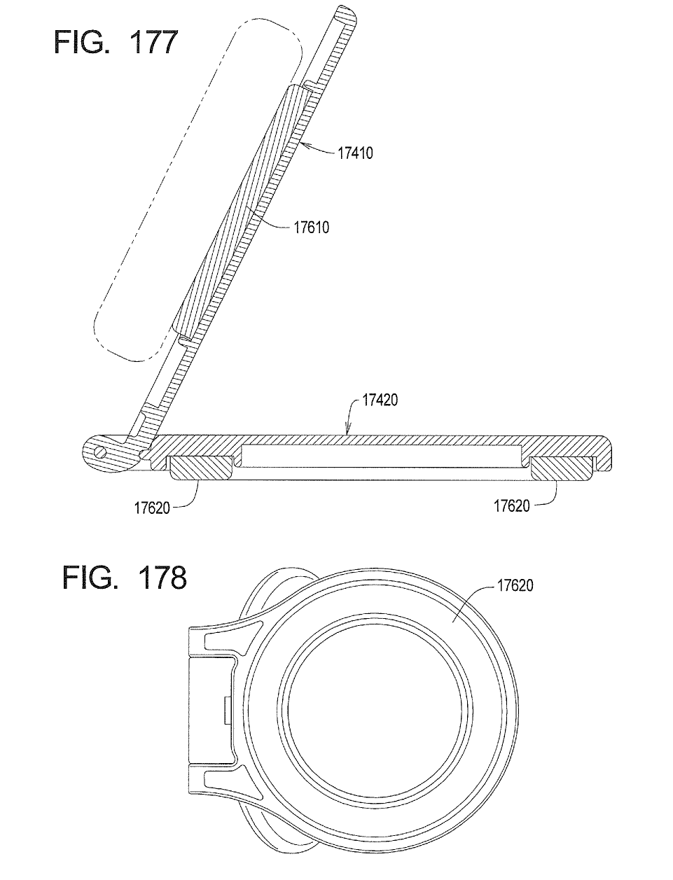

When the stand 17400 is in its deployed configuration, the stand 17400 is pivoted to a position like that shown in FIGS. 175 and 177. The first gripping pad 17610 is used to suspend a portable electronic device and the second gripping pad 17620 is used to secure the stand 17400 to a surface.

The deployed position of the stand 17400 is set by projection 17640 and corresponding recess 17650, along with the other geometries shown in the figures (see, e.g., FIGS. 176 and 177). FIG. 178 is a bottom view of the stand 17400 and shows the second gripping pad 17620.

It should be understood that any male components (e.g., male connectors) may be substituted for female components (e.g., female connectors).

Several embodiments of the invention have been described. It should be understood that the concepts described in connection with one embodiment of the invention may be combined with the concepts described in connection with another embodiment (or other embodiments) of the invention.

While an effort has been made to describe some alternatives to the preferred embodiment, other alternatives will readily come to mind to those skilled in the art. Therefore, it should be understood that the invention may be embodied in other specific forms without departing from the spirit or central characteristics thereof. The present examples and embodiments, therefore, are to be considered in all respects as illustrative and not restrictive, and the invention is not intended to be limited to the details given herein.

What is claimed is:

1. An apparatus comprising:
a display platform having a gripping pad for releasably securing a portable electronic device thereto;
a wing to assist in releasing the portable electronic device from the gripping pad.

2. The apparatus of claim 1, wherein the wing is integral with the display platform.

3. The apparatus of claim 1, wherein the wing is attached to the display platform.

4. The apparatus of claim 1, wherein the gripping pad has a gripping surface that forms a plane and wherein the wing extends in a direction substantially perpendicular to the plane of the gripping surface.

5. The apparatus of claim 1, wherein the wing includes a saddle for receiving a user's thumb or finger.

6. The apparatus of claim 1, wherein the wing is used to rotate the display platform.

7. The apparatus of claim 1, wherein the wing is used to provide leverage to release the portable electronic device from the gripping surface.

8. The apparatus of claim 1, wherein the gripping pad provides a sufficient gripping force such that the portable electronic device stays secured to the display platform when the display platform is rotated.

9. The apparatus of claim 1 further comprising a second wing to assist in releasing the portable electronic device from the gripping pad.

10. The apparatus of claim 9, wherein the second wing includes a second saddle for receiving a user's thumb or finger.

11. The apparatus of claim 1, wherein solely the gripping surface is used to secure the portable electronic device to the display platform.

12. The apparatus of claim 1, wherein the gripping surface is made of polyurethane gel.

13. The apparatus of claim 1, wherein the gripping surface includes a plurality of dimples.

14. The apparatus of claim 1, wherein an arm is attached to the display platform.

15. An apparatus comprising:
a display platform;
a gripping pad having a planar gripping surface attached to the display platform for releasably securing a portable electronic device thereto,
wherein the display platform is moveable to adjust the orientation of the portable electronic device relative to a user.

16. The apparatus of claim 15, wherein the display platform is rotatable.

17. The apparatus of claim 15, wherein the pitch of the display platform is adjustable.

18. The apparatus of claim 15, wherein the roll of the display platform is adjustable.

19. The apparatus of claim 15, wherein the yaw of the display platform is adjustable.

20. An apparatus comprising:
a display platform having a gripping pad for releasably securing a portable electronic device thereto;
an arm that is attached to the display platform.

21. The apparatus of claim 20, wherein the arm and the display platform are attached by a ball joint.

22. The apparatus of claim 21, wherein the ball joint includes a socket in the display platform and a ball on the arm.

23. The apparatus of claim 21, wherein the ball joint includes a socket in the arm and a ball joint on the display platform.

24. The apparatus of claim 20, wherein the arm is fixedly attached to the display platform.

25. The apparatus of claim 20, wherein the display platform is rotatably attached to the display platform.

26. The apparatus of claim 20, wherein the display platform and the arm are releasably attached.

27. The apparatus of claim 20 further including a suction cup for releasably attaching the arm to a surface.

28. An apparatus comprising:
a display platform;
a gripping surface attached to the display platform for suspending a portable electronic device.

29. The apparatus of claim 28, wherein the portable electronic device is releasably suspended from the gripping surface.

30. The apparatus of claim 28, wherein the gripping surface has a surface area, wherein portable electronic device has a surface that is in contact with the gripping surface, and wherein the overall surface area of the surface of the portable electronic device is greater than the surface area of the gripping surface.
